(19) United States
(12) Patent Application Publication
(10) Pub. No.: US 2008/0103878 A1
(43) Pub. Date: May 1, 2008

(54) DETERMINED RIGHTS AND FORWARD OBLIGATIONS FOR FUTURE ITEMS

(76) Inventors: Andrew K. Leach, Hinsdale, IL (US); Richard M. Harmon, Lake Forest, IL (US)

Correspondence Address: STRATEGIC PATENTS P.C.., C/O PORTFOLIOIP, P.O. BOX 52050, MINNEAPOLIS, MN, 55402, US

(21) Appl. No.: 11/849,897

(22) Filed: Sep. 4, 2007

Related U.S. Application Data
(63) Continuation-in-part of application No. 09/586,723, filed on Jun. 5, 2000.
(60) Provisional application No. 60/824,427, filed on Sep. 1, 2006.

(51) Int. Cl. G06F 17/30

(52) U.S. Cl. 705/10

(57) ABSTRACT

The present invention relates to predicting, measuring, and/or guaranteeing demand for a contingent or hypothetical future item and, based upon that demand, determining whether or not to actually produce the future item. In particular, the present invention measures such demand via contingent event certificates and associated marketplaces.

### CROSS-REFERENCE TO RELATED APPLICATIONS

This application claims the benefit of the following provisional applications, each of which is hereby incorporated by reference in its entirety:

Ser. No. 60/824,427, (Demand Aggregation For Events Contingent Upon Threshold Demand) filed on Sep. 1, 2006 by Harmon et al;

This application is a continuation-in-part of the following U.S. patent applications, each of which is incorporated by reference in its entirety:

Ser. No. 09/586,723 (Contingency-based Options and Futures for Event Tickets and Related Goods and Services), filed on Jun. 5, 2000 by Cella et al

This application is also related to the following U.S. patent applications each of which is incorporated by reference herein in its entirety:

U.S. patent application Ser. No. 10/179,634 (Electronic System and Method for Trading Seat Licenses, Event Tickets and Contingent Event Ticket Certificates), filed on Jun. 25, 2002 by Richard Harmon et al.;

U.S. patent application Ser. No. 10/386,741 (System and Method for Executing a Payment Transaction over a Computer Network), which is a continuation-in-part of application Ser. No. 10/179,634, filed on Mar. 12, 2003 by Harmon et al;

U.S. Patent Application Ser. No. 60/674,866 (Methods and Apparatus for Marketing Contingent Event Certificates), filed by Harmon et al;

U.S. Patent Application Ser. No. 60/749,933 (Method and Apparatus for MP3/Live Event Integration), filed by Harmon et al;

U.S. Patent Application Ser. No. 60/674,733 (Methods and Apparatus to Predict Demand for a Product or Service), filed by Harmon et al; and

U.S. patent application Ser. No. 09/586,723 (Contingency-based Options and Futures for Event Tickets and Related Goods and Services), filed on Jun. 5, 2000 by Cella et al.

### BACKGROUND

1. Field

This invention relates to market assessment for future item planning/creation and to generation and aggregation of demand for future items.

2. Background

Oftentimes a future item, such as a consumer product, a service, a book, a video, a concert, a live event, a user-generated content, a collectable, a wine from a region, a vintage of wine, a wine from a winemaker, and the like, is scheduled or developed and the future items go on sale (such as at a sporting event, a book release, a world premiere of content, and the like). In some cases, demand for the future item is underestimated and the items sell out quickly on the primary market for items, in which case items may skyrocket in price on the secondary market for items, as demand outstrips supply. In such cases parties other than future item producers or product manufacturers may reap most of the rewards for high demand, such as by scalping items or engaging in similar practices. In other cases, demand for consumer products or live events is overestimated and item sales languish on the primary market, leading to low product sales for the items, or in the case of live events, low turnout for the event and, in some cases, financial losses for consumer products manufacturers and event producers.

A need exists for improved methods and systems for consumer products manufacturers, consumer services companies or providers, and event producers, to create new product and service offerings which take into account demand for those products, services and events, prior to actual development and funding of these new offers to the public.

### SUMMARY

Disclosed herein are methods and systems for exchanging rights that are associated with future items, including future items that are determined and future items that are defined in terms of a future circumstance. The methods and systems provide for futures and options pricing, purchasing, and selling. The methods and systems provide for pricing, purchasing, and selling certificates, tickets and other rights or evidence of rights to acquire services, goods, rights, and the like, any and all of which may be associated with a future item that is determined or that is defined in terms of a future circumstance. In embodiments disclosed herein, such futures and options may be referred to as contingent access rights, which in turn may be evidenced by or embodied in a contingent event certificate. In certain preferred embodiments a future item may be a product, while in other embodiments the future item may be a service. In other preferred embodiments a future item may be or may not be associated with an event, such as a live event, a product- or service-related event, a broadcast event, a webcast event, a holographic event, or the like. References to future items herein should be understood to include all types of goods, services and events, except where context specifically limits to a specific type of future item.

Also provided herein are methods and systems for demand aggregation, including for future items, including items the manufacture or delivery of which is contingent upon threshold demand. Such methods and systems may allow aggregation of demand based on demonstrated interest in a proposed future item, such as, without limitation, a new consumer product launch, a proposed new consumer service, or proposed new live events. Interest may be reflected in commitments in the form of forward rights which may carry future obligations to purchase, such rights or obligations being contingent on a contingency, such as the aggregation of sufficient total demand or the occurrence of some other contingency, which may be any type of contingency described herein or in the documents incorporated herein by reference. In an embodiment, upon aggregation of sufficient demand, a future item such as a consumer product, a consumer service, or a live event may be produced or scheduled that satisfies the demand of a group of users, or even a single user.

In embodiments demand may be aggregated at least in part based on attributes of contingent event rights, wherein the demand is assessed, and possibly fulfilled, based on attributes of demand that are assessed based on a market for contingent event rights or other related rights. A contingent event right should be understood to encompass at least one of a right and a commitment (and in some embodiments, both) related to a future item, where the right or obligation is subject to a contingency. Many embodiments of contingent event certificates are disclosed herein and in the documents incorporated by reference herein. Embodiments include a wide range of future items (such as releases of products, creation of artistic works, sporting events, travel events, concerts, performances, publications of works, provision of services, authorship events and the like). Future items may encompass a wide range of results, occurrences or outcomes. Embodiments also include a wide range of rights (such as rights to attend an event, rights to attend coupled with commitments, rights to purchase tickets, options to purchase tickets, rights to purchase a work, rights to performance of a contractual obligation, rights to attend a performance, rights to view or otherwise observe an event, rights to ownership, rights to profit, rights to discounts off of list price, rights to distribution, first rights to purchase, rights to market, rights to purchase, and the like). In embodiments rights are evidenced by a certificate or other evidence of right, resulting in a contingent event certificate. Embodiments of contingent event rights also include a wide range of contingencies (such as the presence of a team or player in an event, the presence of a player in an event, the existence of an event, the publication of a work, the production of a performance, the provision of a service, the release of a product, the completion of an obligation, the occurrence of a random event, a weather-related contingency, acceptance levels with a social network, pre-sold commitment levels, pre-published forward sales, and many others). Contingencies may include a wide range of conditions or occurrences not yet established. More embodiments are disclosed below.

In embodiments a contingent event right may relate to an event such as a sporting event, where the contingency is, for example, the presence of a team in a particular game, such as the presence of the Bears in the NFC Championship game in professional football. In embodiments, a contingent event right may relate to a plurality of spatiotemporally related events such as a sporting event and a concert event that are scheduled to occur sequentially or simultaneously at a venue, where the contingency is, for example, the presence of a team in a game and/or a performer in a concert where the game and the concert are spatiotemporally related, such as the presence of the Blackhawks in an National Hockey League Playoff game at the United Center in Chicago and/or the presence of The Black Keys in a concert at the United Center immediately following a Playoff game. In other embodiments a contingency may be related to aggregation of demand, such as tapping a market for user-driven content creation. For example, the future item may be publishing of a book, funding of a business plan, production of a television show, series or miniseries, creation of a film, creation of music, creation of artworks, production of a video game, creation of a consumer product, creation of an electronic device, creation of a toy, provision of a service, or the like, where the future items are the outcomes of a process initially involving assessment of demand for the event, augmented by a marketplace for contingent rights. In such embodiments methods and systems are provided that secure rights and obligations to things which may or may not be created, where the securing of rights and obligations affects the process of creation, such as by establishing a forward market demanding the creation or delivery of an item.

A facility for measuring and tracking the demand for future items, and for generating demand for future items, may be provided separately from, associated with, or provided within an exchange, such as an exchange for contingent event certificates or rights (CECs). References to CECs should be understood to include situations in which either a right, an obligation, or both is tracked by or associated with a certificate. The facility may provide for monitoring of demand by individual customers, members of a social network, such as an online social network, event performers, event providers, producers, consumer products companies, manufacturers, or the like. In embodiments such a user interface may be provided that relates to contingent event rights. In embodiments the user interface may be integrated with a user interface for a social network. In embodiments the user interface may include facilities for sorting events, future items, contingencies and/or rights, such as by: demand; type of event; type of contingency; age rating of video game; type of toy; type of product; type of consumer service; genre, such as music concerts, lectures, meet the celebrity, or the like; performers; locations, such as New York City, Boston, London, or the like; date; venue; and other like variables to be sorted. For example, the most in-demand toys may be displayed in a tag cloud where the toys in the greatest demand may be displayed in a larger font than those toys in lower demand. Since demand may be a function of contingent event rights sold to users whose demand is evidenced by a willingness to purchase contingent event rights, where the contingency is the occurrence of an event having certain attributes. Security measures may also be taken to ensure the validity of each contingent event certificate, such as supplying digital tags to each contingent event certificate. In an embodiment, demand may only be measured for a defined amount of time so that a secondary market may be formed to trade forward rights and/or forward obligations to future items.

It will be appreciated that a future item may encompass, mean, and/or be associated with any and all of a product, service, offering, event, provision, content, occurrence, happening, proceeding, incident, affair, circumstance, occasion, phenomenon, function, gathering, launch, issuance, announcement, declaration, report, revelation, divulgence, disclosure, publication, broadcast, circulation, communication, dissemination, creation, production, generation, making, fabrication, construction, origination, development, formation, and the like. It follows that event planning may, without limitation, encompass, without limitation, the planning of an event, and events should be understood to encompass, as context permits, the union of all of the types of future items described or referenced herein and described or referenced within the documents incorporated herein by reference, according to all of the examples of events within any and all other documents, according to any and all types of event encompassed by the present disclosure, and so on. Throughout this disclosure the term “event” means “event or future item”, as described previously. In embodiments, without limitation, an event may be associated with a consumer product, a consumer service, a live event, and the like, such as creating a new TV show, movie, gaming system, travel planning service, or the like.

Methods and systems for demand aggregation may comprise presenting an offer relating to at least one of a forward right and a forward obligation with respect to a future item, assessing a response to the offer, and determining whether the future item will be produced based on the assessed response. The method and systems may further comprise, if the future item is to be produced, issuing a contingent event certificate to an offeree who has accepted the offer. In the methods and systems, the response to the offer may comprise purchasing a contingent event certificate, obtaining a contingent event certificate at no cost, earning points that may be exchanged for a contingent event certificate wherein earning points may comprise one or more of obtaining a credit or charge card with a retailer, making purchases from a retailer, making purchases directly related to a future item, and serving on a consumer opinion panel, or an acceptance of the future item offer, wherein the acceptance imposes an obligation on the offeree with respect to the future item or provides the offeree with a forward right with respect to the future item. In the methods and systems, the contingent event certificate may or may not obligate the purchaser to purchase the future item if the future item is to be produced. In the methods and systems, the capacity of an offeree to satisfy an obligation related to the future right may be assessed. In the methods and systems, the offeror may be obligated to produce the future item if response to the offer satisfies a threshold condition, wherein the offeror is not a producer or owner of the future item. In the methods and systems, the offeror may have discretion as to whether to produce the future item, regardless of the response to the offer. In the methods and systems, the future item is a consumer product, wherein the consumer product is at least one of an electronic device, a toy, a gaming system, a tool, an item of camping equipment, a household good, a grocery item, a clothing item, and a furniture item. In the methods and systems, the future item is a consumer service, wherein the service is at least one of a social networking service, a job search service, a travel planning service, an accommodations service, a remote executive assistant service, a security service, a help desk service, and an insurance product. In the methods and systems, the future item is the publication of a work, wherein the work is a copyrighted work, such as a book. In the methods and systems, the future item is at least one or more of a music concert, a presentation by a particular person, an opening of a hotel, a sporting event, a consumer product, a consumer service, content, an accommodation, an event, a sporting event, a music event, a theater event, a performance, a music release, a movie release, user generated new content, and a publication. In the methods and systems, the offeror is at least one of a manufacturer, a distributor. a retailer, a producer, and a service provider, wherein the producer is a consumer of the future item. In the methods and systems, an offeree that accepts the offer is entitled to receive a benefit with respect to the future item if the response exceeds a threshold condition, wherein the benefit is at least one of preferred access to the future item, first access to the future item, advance access to the future item, a right to purchase the future item, a right to purchase the future item at a discount, access to a secondary market for rights to the future item, a share of revenues attributable to the future item, a share of profits attributable to the future item, a right to receive an item related to the future item, wherein the related item is an access right such as a right to receive digital media, service such as an accommodations service, digital item, or physical good such as a physical associated with or uniquely associated with a future item. In the methods and systems, offering is done at least in part via the Internet, e-mail, a marketplace, text messaging, a telephone call, an offline social network, or online social network user interface. The user interface may be organized according to an affinity of a user for a topic of interest related to the future item, such as a topic of interest related to an individual. In the methods and systems, the response relates to a preview of the future item, or is a consensus of reviews of the future item exceeding a threshold value. In the methods and systems, the offeree receives a right of preferred access to the future item. In the methods and systems, the offeree receives an additional benefit, wherein the additional benefit is a right to access to a subsequent item or includes a right to receive a share of profits attributable to the future item. In the methods and systems, assessing is done at least in part via the Internet, via a computer software program, or within a social network. In the methods and systems, determining is done at least in part using an Internet website, a computer software program, or includes determining whether the assessed response exceeds a predefined threshold. In the methods and systems, the contingent event certificate is priced according to a pricing method, wherein the pricing method is based on at least one of the marketplace, a Dutch auction, power rankings, or a previous contingent event certificate price.

Methods and systems for future item planning may comprise offering a forward right on a contingent event rights exchange, assessing the demand for a future item based on the market for forward rights associated with the future item, and producing the future item based on the assessed demand. In the methods and systems, offering the future item includes offering a contingent event certificate, which may further comprise associating a contingency with the contingent event certificate. In the methods and systems, the future item may be a sporting event, wherein the sporting event is at least one of a match between two teams, a match between two players, and a rematch. In the methods and systems, the future item is a performance, wherein the performance takes place at a designated time or place, is broadcast over the Internet or a cable television network, occurs within a range of distance and a range of time relative to a specified place and time, is a musical performance, or is a theatrical performance. In the methods and systems, the future item is publication of a copyrightable work, wherein the work is a book or next in a series of works. In the methods and systems, the future item is a consumer product. In the methods and systems, the future item is a service offering.

Methods and systems for determined rights may comprise offering a forward right for a future item, and obligating holders of the forward right to purchase the future item upon its availability. In the methods and systems, the future item is at least one of a consumer product, a consumer service, content, an accommodation, an event, a sporting event, a music event, a theater event, a performance, a music release, a movie release, and a publication. In the methods and systems, the offeror is at least one of a manufacturer, distributor, retailer, produce and service provider. In the methods and systems, the response to the offer comprises purchasing a contingent event certificate.

The present invention also relates to overcoming the deficiencies of current advertising and compensation systems by providing user-driven advertising in association with future item creation. A user of a social networking site may transmit an advertisement to members of his social network. The advertisement may be selected by the user and associated with an endorsement by the user, who may have first-hand experience using the product or service being promoted by the advertisement. The user may receive a referral fee when a direct sale results from providing the advertisement and endorsement to a member of his social network. Moreover, interest in a future item (e.g., a product, a service, an event, an item of content, and so on) may be gauged by recording forward rights, obligations, impressions, or some other measure associated with a user's viewing of the advertisement, acting in response to the advertisement, and the like. When such a measure exceeds a threshold, the future item may be created, commissioned, scheduled, or the like. In an alternative embodiment, interest in a future item (e.g., a product, a service, an event, an item of content, and so on) may be gauged by recording forward rights, impressions, or some other measure associated with a user's viewing of an announcement of the future item, acting in response to the announcement, and the like. When such a measure exceeds a threshold, the future item may be created, commissioned, scheduled, or the like.

Provided herein may be methods and systems for user driven advertising and future item creation. An aspect of the invention may involve method and systems for offering a future item proposition, associating at least one advertisement module with the future item proposition, and receiving at least one impression related to the future item proposition and associated advertisement module.

In a variation of the methods and systems, the counting of an impression occurs each time the contingent client proposition may be transmitted, viewed, forwarded, delivered, printed, or saved.

In a variation of the methods and systems, the advertisement module may be selected from a pool of advertisement modules. In a version of this variation, listing an advertising module in the pool of advertisement modules may require a fee.

In a variation of the methods and systems, the method may further comprise a user endorsement associated with the advertisement module.

In a variation of the methods and systems, the method may further comprise creating the future item upon reaching a threshold number of impressions.

In a variation of the methods and systems, the method may further comprise obtaining at least one of a forward right and a forward obligation for the future item. In a version of this variation, the method may further comprise creating the future item upon reaching a threshold number of forward rights. In a version of this variation, the method may further comprise creating the future item upon reaching a combined threshold number of forward rights and impressions. The value of a forward right may be greater than an impression in calculating threshold numbers.

In a variation of the methods and systems, the method may further comprise generating revenue based on the number of click-throughs.

In a variation of the methods and systems, the method may further comprise generating revenue from a referral fee associated with the advertising module.

In a variation of the methods and systems, the method may further comprise conducting a financial transaction in association with receiving the impression, wherein the financial transaction is associated with a referral fee.

The methods and systems may further comprise conducting a financial transaction that is a function of the number of impressions that are received.

These and other systems, methods, objects, features, and advantages of the present invention will be apparent to those skilled in the art from the following detailed description of the preferred embodiment and the drawings. All documents mentioned herein are hereby incorporated in their entirety by reference.

These and other systems, methods, objects, features, and advantages of the present invention will be apparent to those skilled in the art from the following detailed description of the preferred embodiment and the drawings. All documents referenced herein are hereby incorporated by reference.

### BRIEF DESCRIPTION OF THE FIGURES

The invention and the following detailed description of certain embodiments thereof may be understood by reference to the following figures:

FIG. 1 depicts a logical flow diagram detailing steps in aggregating demand for a future item.

FIG. 2 depicts a demand aggregation platform.

FIG. 3 depicts a logical flow diagram detailing steps in creating future item with associated advertisements.

FIG. 4 depicts a user driven advertising platform

FIG. 5 depicts a trading marketplace for contingent event certificates and associated interfaces and participants.

FIG. 6 depicts a market platform for contingent event certificates or rights along with associated participants.

FIG. 7 depicts a cartoon of a forward rights marketplace.

FIG. 8 is a flow chart of a method of trading PSLs, event tickets, and contingent event ticket certificates according to the present invention

FIG. 9 is a block diagram of a network based exchange according to an embodiment of the invention.

### DETAILED DESCRIPTION

A contingent access right may comprise a right, such as an option, that is associated with a future item, where the right matures or expires depending upon a future circumstance. In embodiments, the contingent access right may comprise a right only. In other embodiments the contingent access right may include both a right and an obligation to conduct a transaction, perform an action, and so on. Thus, in the case that the option matures, the holder of the contingent access right may have both the right and obligation to do something. In other embodiments, the option may comprise a right but not an obligation to do something. Contingent access rights may be embodied as contingent event certificates. As may be described and/or appreciated, many embodiments of contingent event certificates are possible. All such embodiments are within the scope of the present disclosure. Certain embodiments of the inventions disclosed herein may take advantage of features and components of contingent event certificate methods and systems, an exemplary embodiment of which is disclosed in U.S. patent application Ser. No. 10/179,634, the entirety of which is incorporated by reference herein and should be understood to be encompassed in the present disclosure and where demand may be a contingent variable.

Throughout this disclosure the terms “contingent access right” and “contingent event certificate” may be used interchangeably to refer to a contingent access right and/or an embodiment thereof. Throughout this disclosure the phrase “for example” means “for example and without limitation.” Throughout this disclosure the phrase “in an example” means “in an example and without limitation.” Throughout this disclosure the phrase “in another example” means “in another example and without limitation.” Throughout this disclosure, the phrase “such as” means “such as and without limitation.” Generally, any and all examples may be provided for the purpose of illustration and not limitation.

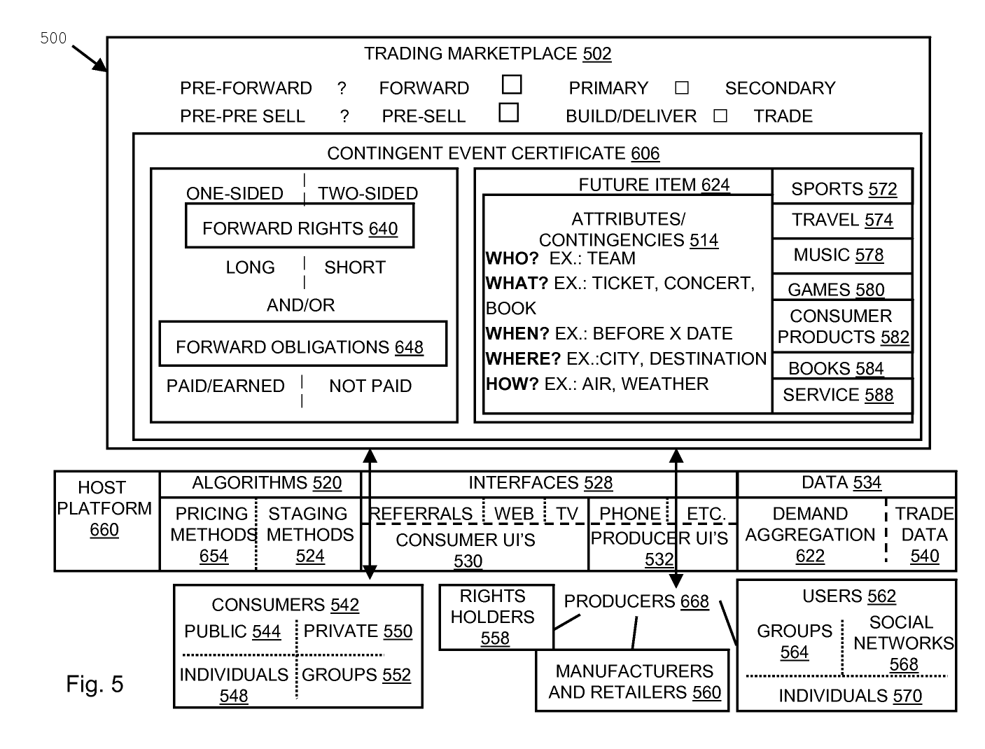

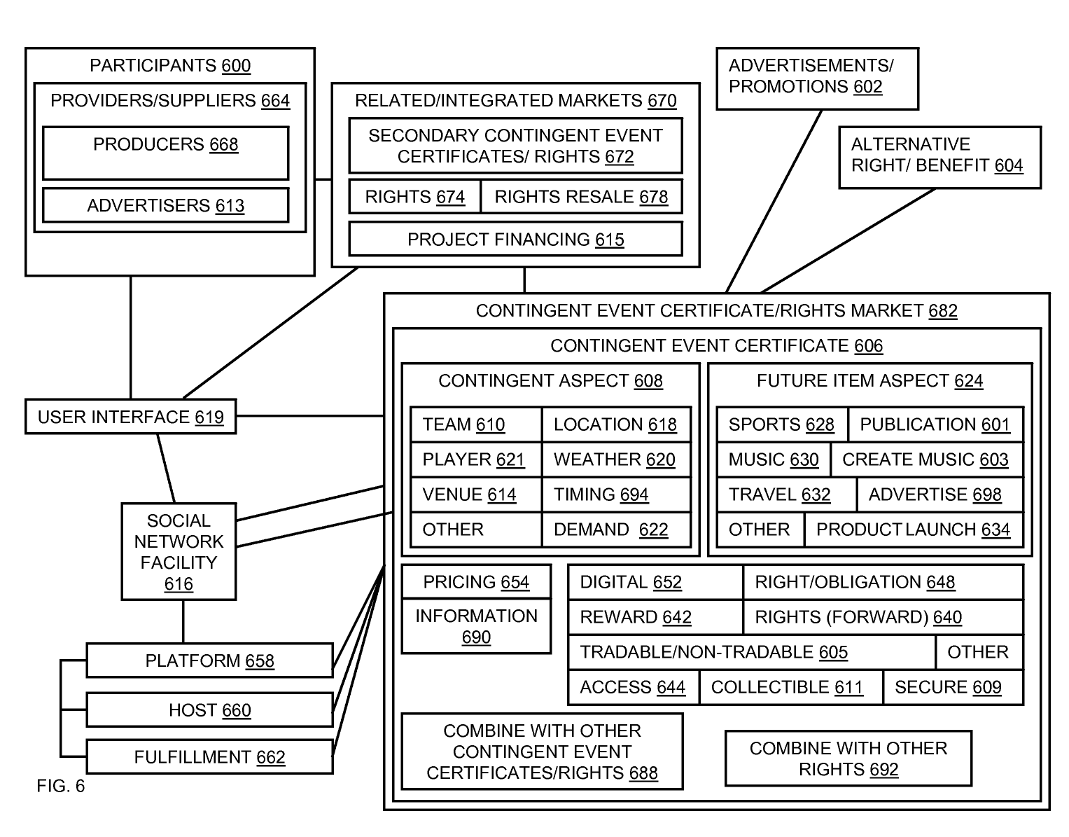

People often buy items, such as products, tickets, and the like, on a primary market and resell them on a secondary market. In embodiments, the items may represent access rights or other rights with respect to a particular event, venue, activity or the like. Where such rights are generally defined or determined at the time of issuance, such as without being subject to a contingency, they may be referred to herein as “defined rights” or “determined rights.” Contingent event certificates may comprise rights, evidence of rights, rights and obligations, or evidence of rights and obligations to acquire something. The rights may be associated with a future item, such as attending an event, buying tickets, purchasing a consumer good or service, or otherwise acquiring a benefit, wherein the rights may be contingent upon a future occurrence or determination, such as aggregation of sufficient demand for the future item, or the like (in some cases referred to herein as “forward rights”). Contingent event certificates and contingent rights are described in detail herein and in the documents appended or incorporated by reference hereto, which may be mentioned hereinafter with reference to FIGS. 5 and 6. Generally, contingent rights may be first sold in a pre-primary market and then traded or resold in a secondary market. As contingencies are resolved, contingent rights may convert, emerge, mature, vest, et cetera into determined rights, which may be first sold on a primary market and then traded or resold in a secondary market. The present invention provides systems and methods that may be associated with a rights marketplace, which may comprise one or more of a pre-primary market, a primary market, and a secondary market. The methods and systems may facilitate allocating an access right to a potential or contingent product, service, or live event based at least in part on a credit amount obtained through consumer activities associated with a producer, service provider, or performer of the potential or contingent live event.

Elements, components, applications, features, systems, methods, aspects, et cetera of the present invention may be described in detail herein and in documents incorporated by reference herein. These documents may include U.S. Patent Application Ser. No. 60/674,733; Methods and Apparatus to Predict Demand for a Product Service (Harmon 1); U.S. patent application Ser. No. 09/586,723 Contingency-based Options and Futures for Event Tickets and Related Goods and Services (Cella); U.S. Patent Application Ser. No. 60/674,866; Methods and Apparatus for Marketing Contingent Event Certificates (Harmon 2); U.S. Patent Application Ser. No. 60/749,933; Method and Apparatus for MP3/Live Event Integration (Harmon 3); U.S. patent application Ser. No. 10/179,634; Electronic System and Method for Trading Seat Licenses, Event Tickets and Contingent Event Ticket Certificates (Harmon 4); and U.S. patent application Ser. No. 10/386,741; System and Method for Executing a Payment Transaction Over a Computer Network (Harmon 6). The entire disclosure of each of the foregoing documents is hereby incorporated by reference. Excerpts from any and all of these documents may be provided below. These excerpts are provided for the purpose of illustration and not limitation. It will be appreciated that the aforementioned documents may provide support for any and all of the elements depicted in the figures and elsewhere, regardless of whether such support is explicit in the excerpts.

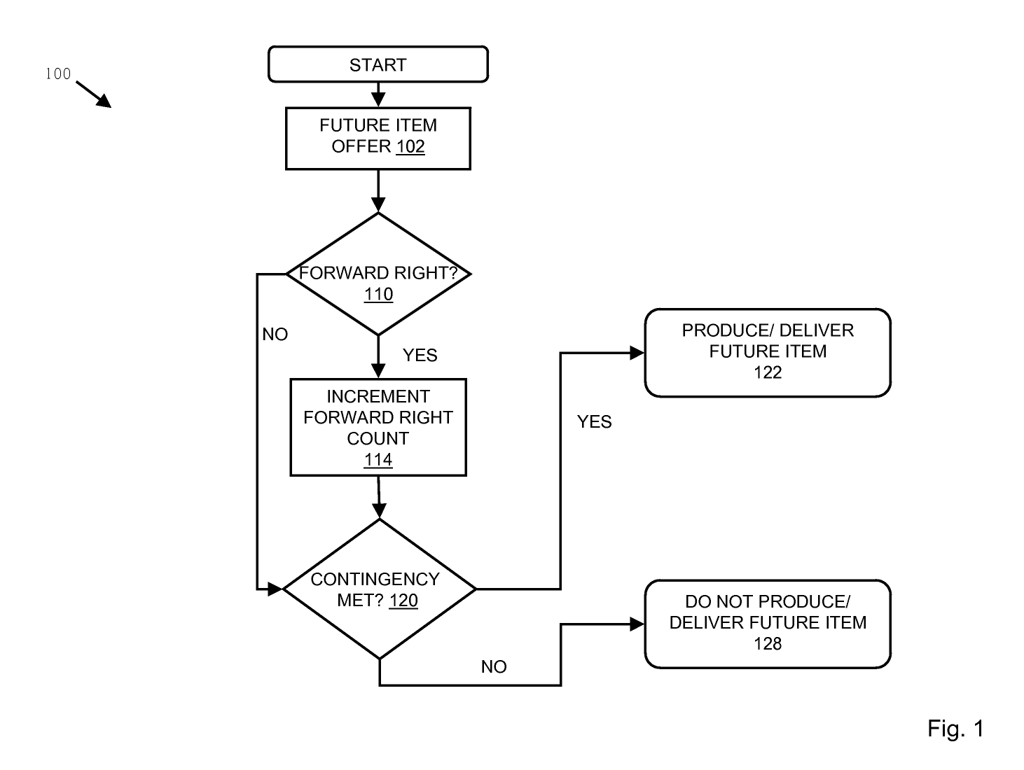

Referring to FIG. 1, a process for demand aggregation may involve offering a future item for production or delivery, wherein the future item may be produced or delivered depending on the interest in the future item as gauged by forward rights obtained to or forward obligations with respect to the future item.

A future item may be one or more of a consumer product, a consumer service, content, an accommodation, an event, a sporting event, a music event, a theater event, a performance, music, a movie, user generated new content, a toy, a game, a consumer electronics item, a work of art, a publication, a book, and the like. A future item may be anything that may be commissioned, produced, designed, created, delivered, built, offered, sold, purchased, traded, exchanged, and the like.

A future item offer 102 may be a communication delivered to audience members, such as and without limitation members of a social network, television viewers, visitors to a website, retail consumers, and the like, to propose production of a future item, delivery of a future item, creation of content, and the like that may be produced by a user or content producer upon meeting a contingency. If a contingency, such as and without limitation, sufficient demand for the future item, is not met the future item may not be produced or delivered. However, an offeror may still choose to produce the future item even if the contingency of aggregating sufficient demand is not met. Other or additional contingencies and/or attributes may be associated with the future item. For example, an attribute or contingency of a future item may be that it is offered for a specific team. In another example, an attribute of a future item may be that it is offered for a specific kind of future item, such as an event ticket, a book, a digital download, and the like. In another example, a contingency or attribute of the future item may be its expiration after a certain date. In another example, a contingency or attribute may be a location associated with the future item. In another example, the contingency or attribute may be how a contingency may be resolved, such as due to an aspect of demand aggregation, the weather, a team standing, and the like.

Offerees may indicate an interest in the proposed future item. Interest in the proposed future item may be indicated by, for example and without limitation, obtaining a forward right 110, which should be understood to include a right, an obligation, or both. Forward rights and/or obligations 110 may be embodied in an advance reservation, contingent event certificate, and the like. Forward rights and/or obligations 110 may be obtained, for example and without limitation, by email, telephone call, instant message, page, website submission, purchase, or the like. If forward rights and/or obligations are obtained, the forward right and/or obligation count may be incremented 114. If no forward rights or obligations are obtained, the forward right and/or obligation count may not be incremented. The production of the future item may be associated with a contingency, such as aggregating sufficient demand for the future item, as measured by reaching a threshold number of offerees indicating an interest in the future item. If a contingency is met 120, the future item may be produced or delivered 122. If a contingency is not met, such as insufficient demand has been aggregated, the future item may not be produced or delivered 128. An offeror may still choose to produce the future item even if the contingency of aggregating sufficient demand is not met.

A forward right and/or obligation to the future item may provide a rights holder one or more of a right to a future item, a first right to a future item such as in an early product release, the ability to trade a forward right, a discount on a future item, a discount on a future item based on when the forward right was acquired, an obligation with respect to the future item, and the like. A forward right may be associated with a forward obligation to purchase the future item. A forward right and/or obligation may be free to obtain, but may commit a rights holder to purchasing the future item at the retail or agreed-upon price.

For the purpose of illustration and not limitation, an example application of the present invention that provides demand aggregation for future items follows. In such an embodiment, a product package, such as a tent with an integrated cooler and barbecue, may be offered as future item to shoppers at a camping goods retailer. The camping goods retailer may have a partnership with a camping goods manufacturer wherein if sufficient demand for the tent is aggregated by the retailer, the manufacturer will produce the tent. In some embodiments, the manufacturer may be obligated to produce the tent. If insufficient demand is aggregated, the tent may not be produced. The retailer may measure aggregation of demand by the number of forward rights (optionally including obligations, rights or both) to the tent obtained by consumers. Forward rights and/or obligations may be obtained by purchase, earned with points accumulated in a loyalty program, an advance reservation, and the like.

In another example, a competition, such as the Ultimate Fighting Championship, may be announced between two participants. Forward rights and/or obligations to tickets to the match may be offered as a future item. The producers of the boxing match may gauge demand for the potential match-up by the number of forward rights and/or obligations sold, obtained, or earned based on the participants announced for the match. The producer of the match may reserve the right to modify the participants, such as, if insufficient demand for the match is observed as measured by sales or procurement of forward rights and/or obligations. The producer of the match may also use the forward market to gauge potential pricing for face value tickets to the match based on the demand for the match. The forward rights and/or obligations offered 102 may be contingent upon the named participants appearing in the final match. If the two participants in the original forward rights and/or obligations offer 102 do not end up in the match, the forward rights and/or obligations may not be applied to tickets to the current match. Alternatively, the producer may choose to honor the forward rights and/or obligations regardless of the contingency not being met. In an alternative embodiment, the producer may be obligated to honor the forward rights.

In another example, forward rights and/or obligations to a NASCAR Cup championship race may be offered at the beginning of the NASCAR season. Racers accumulate points throughout the season to qualify for the championship race. The forward rights and/or obligations offered at the beginning of the season may be contingent upon certain racers appearing in the championship race. If the racer specified in the forward rights and/or obligations contingency does not appear in the championship race, the forward rights and/or obligations may be forfeited. Alternatively, if sufficient demand for a particular racer is gauged based on the number of forward rights and/or obligations purchased, earned, or obtained based on the racer's participation in the championship race, the race administrators may choose to waive the points accumulation requirement and allow the racer to participate in the championship race.

In another example, if a football player announced a desire to be drafted into a football league, forward rights and/or obligations to draft the player to a specific team may be offered. For example, a user may purchase a forward right and/or obligation to see the draftee play in their hometown league. If sufficient demand for a draft of the player to the hometown team is gauged by the number of forward rights and/or obligations sold, earned, or obtained, the player may be drafted.

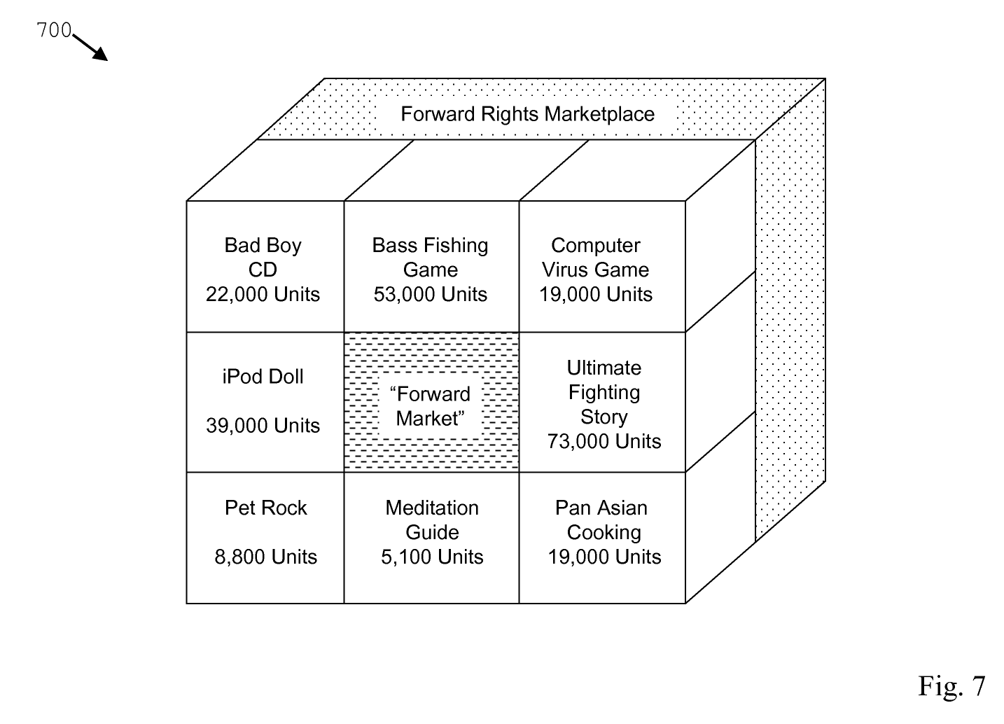

Referring to FIG. 7, a forward rights and/or obligations marketplace may support the forward markets, and demand aggregation of forward rights and/or obligations, for many different kinds of future items, such as a Bad Boy CD, a bass fishing game, a computer virus game, an iPod doll, an Ultimate Fighting story, a pet rock, a meditation guide, a pan-Asian cooking guide, and the like.

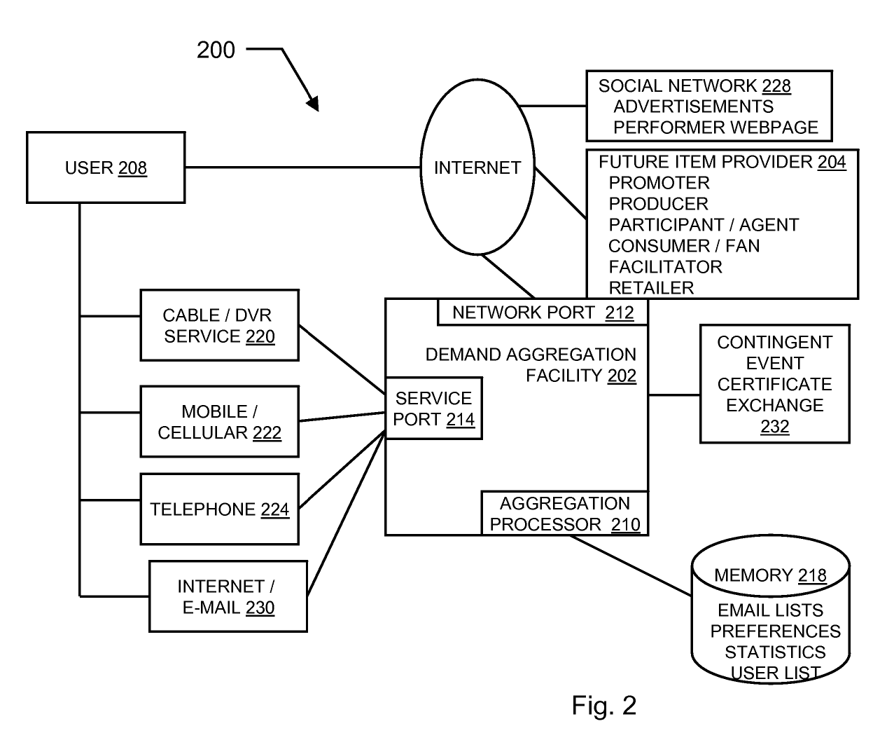

Referring to FIG. 2, elements of the process and steps described in FIG. 1 may be enabled by the system depicted in FIG. 2. FIG. 2 is a depiction of a demand aggregation platform 200, a demand aggregation facility 202 may facilitate a future item provider 204 who is managing planning, preparing, producing, promoting, et cetera a future item, such as a product, service, or event. The demand aggregation facility 202 may allow a future item provider 204 to interact with other future item providers 204 and future item consumers or producers (users 208) to predict, generate, and/or guarantee the demand for a future item associated with the users 208. Future item providers 204 might include a wide range of manufacturers, distributors, producers, directors, and retailers such as for such as video games, cell phones, consumer electronics, toys, books, movies, music, live events and the like; producers, such as performers, producers, directors, executive producers, television executives, production companies, film companies, record labels, studios, publishers, authors, performers, athletes, promoters, team owners, venue owners, tour promoters, concession operators, sponsors, advertisers, or the like. Users 208 may also include consumers, such as sports fans, music fans, members of social networks, members of fan clubs and other affinity groups, fans of particular authors or genres of books, customers with loyalty to particular companies, brands, products or services, and the like. In embodiments, from time to time, one or more of the future item providers 204 may encompass one or more of the users 208 and vice versa. The demand aggregation facility 202 may also facilitate accessing a contingent event certificate exchange 232 through which contingent event rights or certificates for a potential future item may be bought, sold, traded, and exchanged. By facilitating access to the contingent event certificate exchange 232 and aggregating demand associated with a future item, the demand aggregation facility 202 may provide a facility for predicting, measuring, and/or guaranteeing demand of a future item.

The demand aggregation facility 202 may be an electronic facility that includes an aggregation processor 210, a network port 212, and a service port 214. The aggregation processor 210 may be a computer such as a server or personal computer. The aggregation processor 210 may process information related to contingent event demand, communicate to Internet clients through the network port 212, and handle servicing devices through the service port 214. The network port 212 may provide an interface to the Internet that facilitates consumer users 208 and future item providers 204 accessing the demand aggregation facility 202. The aggregation processor 210 may include one or more memories 218 that may store software programs that the aggregation processor 210 executes to process information related to future item demand. The one or more memories may also store data related to future item demand that may be useful in predicting and/or guaranteeing demand for a future item.

Service port 214 may facilitate communication between the demand aggregation facility 202 and a variety of online platform service providers such as Cable TV service providers 220, DSL providers, Internet Service Providers (ISPs), mobile or cellular phone service providers 222, internet/e-mail providers 230, and telephone service providers. The service provider 220 may also include Digital Video Recorder service providers. These service providers, like other producers and providers described above, may facilitate promoting a future item. Through the service port 214, they may also facilitate a user 208 of one or more of the services providing input to the demand aggregation facility 202 regarding a future item and a contingent event certificate associated with a future item.

Network port 212 may, through an Internet connection, facilitate any number of users 208 and future item providers 204 interacting with the demand aggregation facility 202 for purposes of receiving information about future items and providing input to the demand aggregation facility 202 regarding future items and contingent event certificates associated with a future item.

A user 208 may use a computer or other network client device to interact with the demand aggregation facility 202. The user 208 or future item provider 204 may access the demand aggregation facility 202 through the internet through a web browser communicating with a public URL of the demand aggregation facility 202. The user 208 or future item provider 204 may also interact with the demand aggregation facility 202 through email, messaging (e.g. instant messaging), and RSS feeds for example.

The demand aggregation facility 202 may provide an interface, such as a web site or web page that may include screens that a user 208 or future item provider 204 may use to request a future item that might be produced in response to obtaining, from users 208, future item-related commitments (such as and without limitation pre-orders for the future item or future item-related items). The screen may include data entry fields in which a user 208 or future item provider 204 may input information related to a request for a future item. The information may include retailer, performer or performers, type of the future item, location or locale of the future item, timing of the future item, estimated date of delivery for a product, preliminary design prototypes to be shared with those users who own the forward rights and/or obligations, product input sections for users 608 who might influence the ultimate design of the product, and other aspects. The information may be processed by the aggregation processor 210 to define a forward market 2802 for the future item. The aggregation processor 210 may record in memory 218 details about the forward market 2802 that it may later use in predicting and/or guaranteeing the demand for the future item associated with the forward market 2802. The details may include the future item request information input by the user 208 or future item provider 204, registration information provided by the user 208 or future item provider 204, the date and time of the request, and the like.

Referring now to FIG. 28 of Harmon 4, the forward market 2802 data may be provided to the contingent event certificate exchange 232 for purposes of establishing a contingent event certificate market for the forward market 2802. The contingent event certificate exchange 232 may provide contingent event certificate information to the demand aggregation facility 202 for promoting and aggregating demand information about the forward market 2802. The information may facilitate the aggregation processor 210 associating a future item of a forward market 2802 with a contingent event certificate market. In some embodiments, the forward market 2802 is the contingent event certificate market.

The demand aggregation facility 202 may promote a forward market 2802 such that users 208 may receive promotional information about the forward market 2802. The demand aggregation facility 202 may provide promotional information through the service port 214 that facilitates reaching a user 208 of one or more of the services connected through the service port 214. Users 208 may also respond to the promotional material through the service port 214. The communication between the service port 214 and the service providers (620, 222, 224) may allow a user 208 to accept the promotional offer and perform a transaction associated with the forward event 2802 or future item such as purchasing a contingent event certificate through the contingent event certificate exchange 232.

The aggregation processor may access one or more lists of users who may have an interest in a forward market 2802. The list may include contact information for the users such as an email address, an instant message user name, a cell phone number, and a telephone number. The list may be derived from a variety of sources including purchasing the list from a user list provider. The list may include previous users of the demand aggregation facility 202 or the contingent event certificate exchange 232. The demand aggregation facility 202 may contact one or more of these users to provide promotional information about the forward market 2802.

In an example, the demand aggregation facility 202 may make automated promotional telephone calls through the service port 214 to user telephones 224. The promotional call may include voice and or audio content that the user 208 may receive directly by answering the telephone 224 or by later retrieving a voice mail message of the call. The promotional call may include information about the forward market 2802, and the contingent event certificate market. The user may respond to the promotional call through a variety of ways including making a telephone call to the demand aggregation facility 202 for automated processing. In an example, a promotional call from the demand aggregation facility 202 may include one or more phone numbers that the user may call to reply to the promotion. At least one of the phone numbers may permit the user 208 to purchase a contingent event certificate for the forward market 2802. A call to the purchase phone number may charge the cost of the contingent event certificate to the user's phone bill. The purchase phone number may be managed by the contingent event certificate exchange 232.

In another example, the demand aggregation facility 202 may send a text message to the list of users 208 through the mobile/cellular service 222 that may include reply information as well as contingent event certificate market related information.

A user of a cable/DVR service 220 may receive a promotional message such as an advertisement from the demand aggregation facility 202. The user may select to reply to the promotion through the cable/DVR service provider pay per view transaction service to purchase a contingent event certificate for the forward market 2802. The cost of the contingent event certificate would be charged to the user's cable/DVR service account. The demand aggregation facility 202 may facilitate communicating the user's reply to the contingent event certificate exchange 232 and may facilitate communicating the contingent event certificate information to the users cable/DVR service 220 such that the contingent event certificate information may be provided to the user through the cable/DVR service provider 220 (e.g. through an email to the user's account or by hard copy monthly billing).

The demand aggregation facility 202 may promote the forward market 2802 through the internet and e-mail 230. The demand aggregation facility 202 may process the future item request information to generate a list of keywords appropriate for use in an internet advertisement search engine campaign. The demand aggregation facility 202 may automatically generate an Adword campaign with search engines such as Google and Yahoo Search that would provide sponsored results promoting the forward market 2802. The demand aggregation facility 202 may process the future item request information to generate an e-mail to be sent to a mailing list promoting the forward market 2802.

An advertisement or promotion 202 may include any and all forms of advertisement or promotion 202 including—without limitation—a referral, a billboard, an animated billboard, a balloon sign, a directional sign, a signboard, a sky sign, a banner, a graphic, a text advertisement, an email newsletter, a page sponsorship, a section sponsorship, an article, a paid feature article, a printed advertisement, a digital advertisement, an audio advertisement, a video advertisement, a live promotion at an event, an outdoor advertisement, a text message, an email, a webpage, a widget on a webpage, a banner advertisement, a promotional web link, and so on.

In one preferred embodiment, users may access the contingent event certificate exchange 232 directly as herein described. As users make purchases of contingent event certificates for the forward market 2802 through the contingent event certificate exchange 232, the contingent event certificate exchange 232 may send purchase information to the demand aggregation facility 202 for processing. The information may include contingent event certificate purchase quantity, cost, purchaser contact information, method of payment, and the like. The information may be provided with each transaction or may be accumulated and sent periodically such once per day.

The aggregation processor 210 may receive this information and generate a prediction and/or guarantee of demand (or, where the contingent right includes a commitment to exercise the right if the future item is produced, a measurement of actual demand) for the forward market 2802. The prediction, measurement, and/or guarantee of demand may be as simple as a count of contingent event certificate sales. However, it may include additional analysis such as average contingent event certificate price, contingent event certificate sales rate, contingent event certificate resale information, and the like.

A user 208 or a future item provider 204 may access the forward market 2802 prediction and/or guarantee information through the network port 212 of the demand aggregation facility 202 using a web browser. The demand aggregation facility 202 may provide the forward market 2802 prediction and/or guarantee information through email, messaging, RSS feed, and the like to the user 208 or future item provider 204 by accessing contact information they may have provided when they requested the event. In particular, the future item provider 204 may decide, based on either a prediction and/or guarantee of demand or based on actual demand, whether in fact to produce or offer the future item. Thus, the exchange of contingent event rights enables the prospective generation of demand for future items, by obtaining commitments from users 208 that are triggered by the actual production of the future item.

A user 208 or future item provider 204 may also interact with the demand aggregation facility 202 through a social networking interface 228 associated with the demand aggregation facility 202. The social networking interface 228 may be integrated with the demand aggregation facility 202, such as with a common user interface, or it may be linked to the demand aggregation facility 202, such as from a common social networking Internet site. The social networking interface 228 may include a wide range of features, including news and features associated with a topic of interest (such as to a group with an affinity for a particular sports team, movie genre, actor, or the like), blogging tools (allowing users to publish content), communication tools (such as instant messaging, chat rooms and the like, and other features. The interface 228 may also allow for advertising, which may be targeted to users based on the subject matter of the contingent event rights. In embodiments the social networking interface 228 may enable users to generate proposed contingent event certificates, such as by allowing users to complete a form (such as an XML, HTML or RSS form) that includes necessary elements of a contingent event right, such as the details of the future item, the contingency, and the price. The social networking interface 228 may allow users to generate and share proposed contingent event rights with other users 208 and with future item producers and providers 204. For example, a user 204 may generate a form that captures the proposition that the user wishes to sell a product. The social networking interface 228 may provide an interface whereby the user can enter product information, such as summary information about the product, product prototype, pricing information and the like and generate referrals for the book. If sufficient demand is generated, such as by reaching a threshold number of pre-sold books, a publisher may be obligated to publish the book. In another example, a user 204 might generate a form that captures the proposition that the user wishes to attend a Rolling Stones concert in Lincoln, Nebr. between October 7 and October 20 of 2007. The social networking interface 228 may provide an interface whereby the user can enter event information, location information and date information, whereupon the proposed contingent event right is displayed for evaluation by other users 208 and producers 204. A producer 204 may, for example, offer the contingent event right and/or obligation if the producer is capable of satisfying demand for the future item upon emergence of the contingency (such as, in this example, if the producer is a tour promoter for the Rolling Stones). Other users 208 may, upon presentation of a proposed contingent event right and/or obligation, indicate interest in (or a commitment to purchase) the contingent event right and/or obligation in question, thereby allowing providers 204 to evaluate what contingent event rights to offer. Thus, the social networking interface 228 may allow users 208 and providers 204 to generate a list of prospective contingent event rights and/or obligations, to comment on such rights and/or obligations, to propose modifications to such rights and/or obligations, to indicate demand for such rights and/or obligations, and, ultimately, to offer such rights and/or obligations through the associated contingent event certificate exchange 232.

In other embodiments, users 208 of a third party social network may, in their social network web page or web pages, include links such as HTML links to a URL associated with the demand aggregation facility 202 that is related to a forward market 2802 for a future item. The URL may be provided when the future item is requested. The URL may direct a user 208 to a web page that may allow the user 208 to get more information about the future item or user generated proposal for new content. The web page may provide prediction- and/or guarantee-related information, contingent event certificate exchange 232 access information (e.g. a link to the contingent event certificate exchange 232), and the like.

The demand aggregation facility 202 may be integrated within the contingent event certificate exchange 232. Also, users 208 may have an interface to the contingent event certificate exchange 232 through social networks such as MySpace, Friendster, Facebook, Gaia Online, orkut, Piczo, Yahoo! 360, and the like. For instance, the Internet social network MySpace has online associations to independent music and party gatherings, retailers, manufacturers, distributors, and the like, and may provide an integrated interface to the contingent event certificate exchange 232. A MySpace member may request a future item, such as a new music concert with a targeted artist and targeted venue or a new Electronic Arts video game through the demand aggregation facility 202, and monitor the aggregation of demand for the future item. This aggregation of demand may generate interest from the targeted artist or video game producer who then may set a demand threshold for enabling the future item to be produced. Alternatively or additionally, the artist or video game producer may set the demand threshold in advance of the aggregation.

The demand aggregation process may encompass a dynamic interaction between user 208 demand for a future item, and the future item provider's 204 required demand threshold to enable the future item to be produced. An Internet social network member may establish a forward market 2802 for a future item that is not yet available, such as a consumer product, a consumer service, a music concert, a meeting of an artist, a match-up between sports teams, a lecture by a famous individual, or the like. Members of the Internet social network may then purchase contingent event certificates for the forward market 2802 and thereby aggregate demand for it. As herein described, the demand aggregation facility 202 may communicate aggregated demand data to a future item provider 204. A future item provider 204 may in turn set a demand threshold for the future item to be produced, such as Bob Dylan requiring a demand of 20,000 contingent event certificates for a concert at Red Rocks, Colo., or the physicist Stephen Hawking requiring a demand of 2,000 contingent event certificates for a lecture at Albert Hall, London, or a 1970's punk rock star requiring 200 contingent event certificates to come to a large party to meet the guests, or a social network user requiring 1,000 contingent event certificates for creation of a new game that revolves around the infection of computer viruses within a community, or Nintendo requiring 250,000 contingent event certificates to produce the next generation of a gaming system, or Electronic Arts requiring 25,000 contingent event certificates to produce a sequel to an existing game, or the like. It will be appreciated that demand aggregation may encompass, without limitation, demand-based production or a process of taking something from an idea state to a reality state (or not, in the case of insufficient demand).

Once a contingent event certificate is purchased, it may not be sold, until the minimum demand threshold is reached or until a marketplace for a given item is closed. The selling and trading of contingent event certificates may be facilitated within the contingent event certificate market platform, such as with contingent event or forward rights and/or obligations issuers, or within a secondary market place for contingent event or forward rights and/or obligations. Contingent event or forward rights and/or obligations may be bought and sold within the controlled environment of a contingent event certificate market platform. If the demand threshold for a future item is met, then the future item may be produced and purchasers of contingent event certificates may be obligated to purchase the future item or access to the future item, such as a ticket, at the retail or agreed-upon price. If the demand threshold is not met, the holders of the contingent event certificates may, or in some embodiments may not, receive refunds for the cost of their contingent event certificates. In an embodiment, contingent event certificates holders may pay nothing for the contingent event certificate, but will assume the obligation to purchase if the contingency, such as demand levels, is met. The process of aggregation of demand may drive a future item from being contemplated, such as an idea for a book, to being produced, offered, scheduled, or populated, such as publication of the book, and finally fixed for sale or, in the example of the book, shipped to contingent event certificate holders. Once the future item is fixed, contingent event certificate holders may be able to purchase the actual future item. If demand does not reach demand threshold, no future item may be produced. And during the process of demand aggregation, a secondary market place may allow contingent event certificate holders to financially profit from the selling of contingent event certificates. For example, a forward market may be closed after a certain period of time or reaching a threshold of demand aggregated so that trading of forward rights and/or obligations on a secondary marketplace may begin.

Future item providers 204 may register through an interface of the demand aggregation facility 202 to facilitate being available for future items. Future item providers 204 may include manufacturers, distributors, retailers, performers, such as musicians, celebrities, lecturers, sports figures, entertainers, game developers, artists, individuals, amateurs, or the like, or may include other individuals or entities that facilitate production of a future item, such as described herein. A future item provider 204 may specify conditions under which the future item will be produced, such as if a certain minimum amount of money is guaranteed; if the event is in a certain location, date, venue; if there is a guaranteed number of performances per year; or the like. A future item producer or provider 204 may contractually bind themselves to these specified conditions thereby enabling the demand aggregation facility 202 to generate a forward market 2802. The future item producer or provider 204 may monitor the demand aggregation for the future item using the demand aggregation facility 202 web pages. Of course, the future item producer or provider 204 may choose to accept conditions outside the initially specified conditions if a prediction and/or guarantee of demand indicates acceptance may be beneficial for the future item producer or provider 204. For example, if a products manufacturer had originally specified only certain features of a new tent, but the demand aggregation facility 202 predicts and/or guarantees a good demand for the tent, they may choose to add additional features to the tent. In another example, if an event performer had originally specified New York City as the only performance location, but the demand aggregation facility 202 predicts and/or guarantees a good demand for them to perform in a different city, they may accept the new location and enable the performance to take place.

In embodiments, future item providers 204 may bid for the right to issue contingent event rights for a particular future item. Thus, the demand aggregation facility 202 may include a bidding interface that allows providers 204 to bid. The bidding interface may, for example, award a right to issue contingent event rights for a particular future item to the bidder offering the most favorable price, the most desired future item, or the like. For example, if a proposed contingent event includes a contingent accommodation event (such as providing a room for two in Boston if Paul McCartney plays a concert there in the first week in December), then different accommodations providers may bid for the right to offer the contingent accommodations. In embodiments multiple providers 204 may be allowed to offer the same contingent event right, in which case a user may be offered a choice of provider 204 (such as a particular hotel, restaurant or the like associated with attendance of a contingent event). Alternatively or additionally, the user may issue contingent event or forward rights and/or obligations and, upon selling an adequate number of them, tell a provider 204 to produce the future item or have a plurality of providers 204 bid on the rights to produce the future item. For example and without limitation, a user may publish an outline for a book that he proposes to write. In response to this outline, perhaps 200,000 or more forward rights and/or obligations may be sold that obligate the holder of the right to purchase a copy of the book if and when it is published. Armed with this aggregation of forward rights and/or obligations, the user may put the right to publish the book up for bid. A plurality of providers 204 may then bid on the publication rights to the book, knowing that each contingent event right represents a guaranteed order for a copy of the book. The plurality of providers 204 may also bid to get access to the social network and/or the contingent event certificate marketplace. Many other such examples will be appreciated, and all such examples are within the scope of the present invention.

Thus, the demand aggregation facility 202 described herein helps support the creation of user driven content, (products, services, inventions, businesses, books, movies, etc) through the power of an organized social network. It is an approach of future item creation (including content future items, such as publications of works) from the bottom up. Thus, rather than having products imposed on them by producers, users can ask for the products they want, and if demand is sufficient, can encourage the generation of non-standard future items. For example, if a small number of users is willing to pay a large amount for a Star Wars collectible figurine, these economics would allow a provider 204 to produce this figurine without risk while satisfying the users 208. Thus, by operating as and in association with a demand aggregation facility 202 a contingent event certificate exchange 232 offers users opportunities to purchase rights (contingent rights, that is) to experience things not yet known or created. A contingent event right is thus the key to supporting the creation of a future item, such as associated with a social network of users who share common desires for particular future items.

In one embodiment, a demand aggregation facility 202 may track “hot markets.” The facility 202 can, for example, have “ramp up monitors” or other metrics that monitor aggregation of demand for future items, such as showing providers 204 and users 208 of the social network interface 228 or other interface of the demand aggregation facility 202 the “up take” of various creative initiatives. Producers could evaluate demand for consumer products, consumer services, books, live music events, music CD's, video games, sports matches and the like to see what future items are getting the most traction. An interface can show periodic totals for demand, such as daily and weekly totals (for a book 1,950 copes daily, 14,600 weekly) and can show future projections based on the uptake numbers to date as well as the building “speed of uptake” as a variable. Under the school of thought—a winner has 1,000 fathers, a loser is an orphan, hot uptake markets could prosper. It is in effect, the demand aggregation facility 202 can include a “ticker” of sorts for tracking popularity of particular contingent rights.

Thus, in contrast to a market where production currently requires investment in advance of sale of rights and/or obligations, a contingent event rights marketplace allows investment to follow the aggregation of demand that justifies the investment. The rights and/or obligations are in advance (in a forward market), rather than having the market react, unpredictably, to an item that has already taken shape, perhaps the wrong shape, at the expense of the provider.

In various embodiments described herein, any attribute with respect to which a contingent event certificate may be issued may be an attribute about which demand can be assessed or aggregated. For example, a contingency may include the presence of a team or player in a particular round or game of a sporting season or event, the occurrence of a live performance by a particular performer or group in a particular venue on a particular date or during a range of dates, the issuance of a work by an author or performer having certain characteristics (such as characteristics as to theme, character, plot, location, time period, occurrence in a series of related works, inclusion of particular works in a collection of works, or the like), the production of a television show or movie with certain desired characteristics (theme, stars, director, position in a series, etc.), the publication of a book, the supply of a product, service or technology having certain desired attributes, or other type of contingency.

Future item planning, preparation, production, and promotion often take on financial risks associated with the financial success of the future item. A demand aggregation platform may facilitate managing financial and business risks associated with producing consumer products and services and other contemplated future items and events by providing an opportunity to assess the interest in the contemplated future items and events.

In one example of a contingent rights exchange, an author of a fiction novel may write a summary premise (a bit like reading the back cover or a review today, summary info) and distribute it to the social network via the social network interface 228. Initially, the author may not know if the book will gain enough traction to get published or not (it is contingent). In order to “measure” the commitment the author may sell forward rights on a contingent basis. In effect, the author is asking the social network: “IF my book gets published/written, will you commit to purchase it?” Thus, the forward right and/or obligation may include a right and obligation to purchase if these contingent variables align, are met; in this case, for example, a book passing a particular mark in “pre-sales.” With a retail price of $19.50 (this is in fact our “face-value” as defined today in sports), and 200,000 forward commitments, the author has secured $3,900,000 in advance revenue. The instrument is contingent in that the author might only get 20,000 “commitments” which means it will not get published.

In an embodiment, a forward right and/or obligation may be evidenced by a certificate or other document evidencing ownership. In the example of the book, the author may not charge anything for the rights to a first run copy of the book, but structure the “certificate rules” that it is an obligation only in the event of the creation. These rules could be user-defined rules, or sit inside a harder framework such as books, music, movies, business plans. Some form of framework with limited user/producer configuration abilities may be provided. In the book example, consumers 208 could be rewarded if demand exceeds various thresholds, such as by reduced cost, or even free goods, such as offered to the earliest purchasers of contingent event rights. Algorithms may be provided to allocate benefits to users 208 who help generate demand. In a sense, as more people join in, more benefits can be allocated. For example, as demand increases, a provider 204 can lower the cost to initial consumers 208 who initiated demand, and, as demand increases even further, such initial consumer 208 might be provided a free event, or even a share of the profits (effectively rendering some consumers 208 co-producers for the event). The producer may always be the author (one who first originated the concept) but a certain number of users 208 may become “co-producers” as momentum builds. In fact really everybody is a “co-producer” of the book, just on different levels. To some extent the system can take on attributes of a multi-level marketing approach. In some cases just getting the first release of the book or early access to content creation might be enough incentive, but in others that might not be enough to drive the creation. The financial incentive for these types of projects may be critical in that it drives a “get in early” type of mentality. Even those who get in late, say number 397,000 in the queue, really are only late if the “market” closes at 425,000. If it goes to 1,200,000 copies, 397,000 may be sufficiently early. And in fact, markets may be constructed to close at some point. So in addition to the rules definition (the certificate component) the contingent rights market might include various features such as levels of “producer.” The categories could be assistant producer, senior producer, executive producer, co-producer, and founding producer. These all would have predefined “payouts” and providers 204 could be incented to push the social network on ideas to drive both the providers and the network's level of attainments. So to some extent not only does a user buy that which the user creates, the user can control to some degree, what it is that the user pays for the creation. The financial rewards could also be a function of trading forward rights.

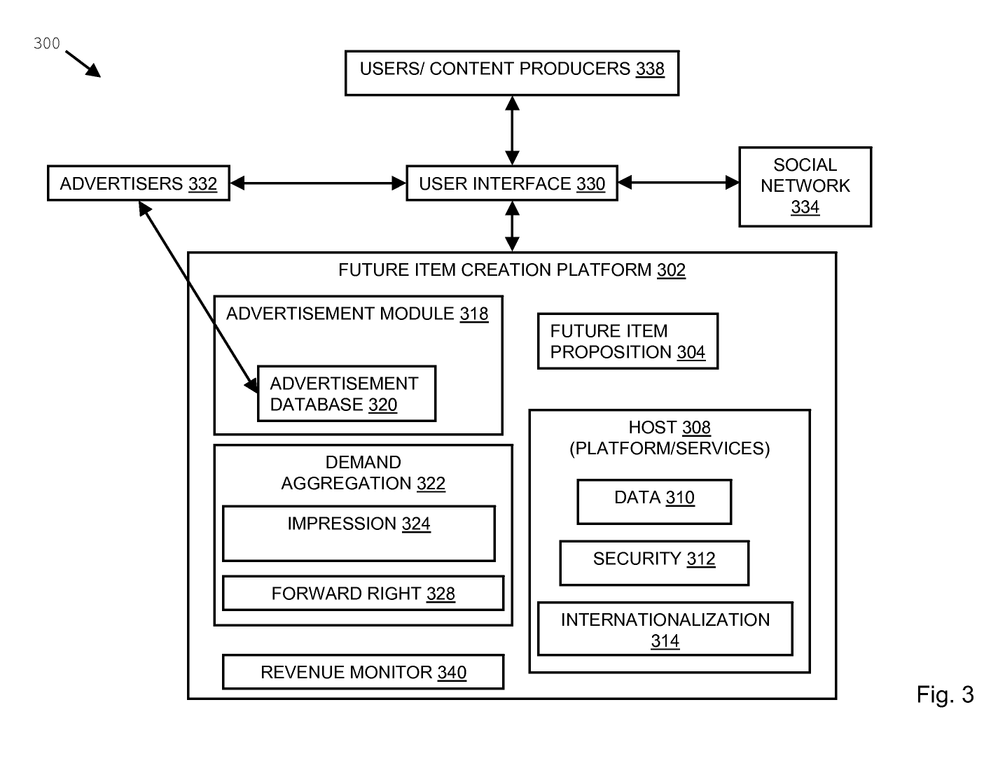

Referring now to FIG. 3, the present invention may also enable user driven advertising and contingent content or future item creation. In embodiments, a user may propose creation of a future item, such as contingent content, or user-generated new content, to consumers or producers, where each proposition may be accompanied by an advertisement 302 of their choice, which may be accompanied by an endorsement of the advertised future item. The future item may be produced depending on the interest in the project as gauged by forward rights obtained and/or impressions. In other words, users who propose future items may include advertising associated with their proposals, and either get paid directly based on views, clicks, or impressions associated with the advertisement, or associating the advertisement with the proposal may be a means to reduce their threshold for demand aggregation. For example, a user may propose a new cookbook they want to write concerning BBQ and seafood. In the proposal being distributed around a social network, the user may insert an advertisement selected from an advertisement database. Since the proposal and associated advertisement is going out to the social network, which may comprise friends and fellow cooks, the user may pick an advertisement for a new cooking accessory and associate a comment with the advertisement, such as “I have used this new hand mixer and found it very useful . . . you guys will love it too!!” An advantage of associating an advertisement with the book proposal may be that if the book portion of the market requires 40,000 CEC commitments, utilizing an advertisement with the proposal may reduce the requirement to 35,000 CEC commitments.

An aspect of the invention may involve a system for future item proposition 304, comprising a future item creation platform, a user interface, users/content producers, a social network, and advertisers. In embodiments, the social network may be substituted for any suitable audience. The platform 302 may comprise the content creation platform, which may be hosted on the host 308. In such cases, the platform 302 may be referred to more specifically as the content creation platform 302. Generally, however, embodiments and applications of the platform 302 are in no way limited to platforms 302 for or associated with content creation. Indeed, some embodiments and applications of the platform 302 may have little or nothing to do with content creation. Therefore, references to “the content creation platform 302” are provided for the purpose of illustration and not limitation.

The host 308 may provide software-based services for users of the future item creation platform 302 that may provide personalized access capabilities, which may be adapted for participants 300, producers 368, advertisers 313, or the like. Users may have customized access to host services of the future item creation platform 302 through a web portal, where access may be dependent upon the type of user, such as a username/password customer interface for a forward right and/or obligation 328, a secure access for users, customer service access for advertisers 313, or the like. The host 360 server may provide access to data storage for users of the future item creation platform 302, such as user information, billing information, content information, contingent conditions, or the like. The host 360 server may also provide facilities for providing confirmed forward rights and/or obligations to users, system security, internationalization and technological interface to users, or the like.

The future item creation platform 302 may facilitate a future item creation proposition. A future item proposition 304 may be a communication delivered to audience members, such as and without limitation members of a social network, to propose creation of content that may be produced by a user or content producer 338 upon meeting a contingency. If a contingency, such as and without limitation, sufficient demand 322, is not met, the future item may not be created. Future items may be, for example and without limitation, a consumer product, a service offering, a literary publication, music, fashion, art, events, or any and all other kinds of content or future items.

The future item creation platform 302 may facilitate associating an advertisement 318 with the future item proposition 304. An advertiser 332 may utilize the future item creation platform 302 to populate an advertisement database 320. A user may use the user interface 330 to the future item creation platform 302 to select an advertisement 318 from the advertisement database 320 and, optionally, add commentary, reviews, editorials, and the like to the advertisement 318 and associate the advertisement 318 with the future item proposition 304.

A user interface 330 to the future item creation platform 302 may be associated with a social network facility 616. The social network facility 616 may provide social networking functions so as to enable a social network 334.

The future item creation platform 302 may have an interface with a social network facility 616, the social network facility 616 providing an Internet social network 334. This interface may be programmatic or comprise an operative coupling between the social network facility 616 and the platform 302. Alternatively, the interface may result from social interactions within the social network 334. The interface between the future item creation platform 302 and the social network facility 616 may enable initiation of a future item creation proposition, association of an advertisement 318, sending future item propositions 304 to a members of a social network, monitoring of the aggregation of demand 322 within a social network 334, monitoring of revenue generation within a social network 334, or the like. The interface may be implemented as an information exchange between servers of the social network facility 616 and the future item creation platform's 302 host 360 servers. In embodiments, this exchange may be implemented according to SOAP, XML-RPC, or according to any and all other protocols for information exchange between networks, computers, and the like.

The user interface 330 may provide information that is sorted by demand; genre, such as music, lectures, fashion, art, or the like; location; performers; language; date; and so on. Since demand is a function of forward rights and/or obligations, security measures may also be taken to ensure the validity of each forward right and/or obligation, such as supplying digital tags to each confirmed forward right and/or obligation. An individual or a group may initiate future item creation through the user interface 330 between an Internet social network 334 and the future item creation platform 302. For instance, an Internet social network 334 may have online associations to independent music and party gatherings, and may provide users with access to these in an interface that also includes access to features or functions of the future item creation platform 302. In embodiments, a user of a social network 334 may initiate a future item creation proposition for a new music album featuring various folk artists and then may monitor the aggregation of demand 322 for the album. This aggregation of demand 322 may generate interest from a music studio that then may set a demand threshold for enabling the album to proceed to production. Many other like examples will be appreciated all such examples are within the scope of the present disclosure.

Future item creation may be contingent upon the demand 322 that is aggregated for the content through impressions and forward rights and/or obligations. The demand aggregation process may be a dynamic interaction between demand 322 for proposed content and a content producer's required demand threshold to enable the content to be generated. An Internet social network member may generate a future item proposition 304 for a future item that is not yet available, such as a new video game, a music album, a collaboration of two writers, an article by a famous intellectual, or the like. Members of the Internet social network may then make forward rights and/or obligations for the future item and thereby aggregate demand 322 for the future item. Demand 322 for the future item, in the form of impressions and forward rights and/or obligations, may be communicated to users. A user may in turn set a demand threshold for the future item to be produced or generated, such as and without limitation by requiring a demand of 10,000 forward rights and/or obligations for a book written by a new writer. A facility for measuring and tracking the demand 322 for future items may be provided within the future item creation platform 302. The facility may provide for monitoring of demand 322 by individual customers, members of an Internet social network, content producers 338, or the like. In embodiments, a user may use the user interface 330 to receive an alert if the threshold for demand 322 aggregation is exceeded.

A future item may be contingent content that is produced or generated by a user upon meeting a contingency. For example and without limitation, a user may propose to write a fictional book based on a recent gubernatorial race. An element of the proposition may be that the user does not write the proposed book unless a contingency is met. The contingency may comprise a demonstration of interest in the proposed book by a threshold number of audience members. A user may propose the future item to an audience. The audience may be, for example and without limitation, members of a social network. A user may propose the future item using electronic mail, a bulletin board posting, a web page, an instant message, a voicemail, a page, a telephone call, a letter, and the like. Many such future item propositions 304 will be appreciated and all such future item propositions 304 are within the scope of the present disclosure.

The user may associate an advertisement 318 with the future item proposition 304. The user may select the advertisement 318 from a database of advertisements 320. Advertisers 332 may be charged a fee to include their advertisement 318 in the database of advertisements 320. Alternatively, the advertisement 318 may be a link to a web page, an email, a brochure, an image, a video, or the like. The user may choose to not associate an advertisement 318 with the future item proposition 304. The advertisement 318 may or may not be related to the subject matter of the future item proposition 304. The user may provide an endorsement of the advertised goods or services in the associated advertisement 318. The endorsement may be a review, a comment, an editorial, or the like. In some embodiments, association of the advertisement with the proposal may serve to reduce the threshold for demand aggregation.

Input may be received when an audience member accesses the advertisement 318. Upon receiving the future item proposition 304 and its associated advertisement 318, the audience member may view, hear, or otherwise receive an “impression” of the content and/or the advertisement 318. In embodiments, the audience member may perform additional actions that are associated with the future item proposition 304 and its associated advertisement 318, such as printing, emailing, saving, et cetera and these actions, too, may be counted as impressions. Thus, the total number of impressions may be equivalent to the total number of actions performed with the future item proposition 304 and advertisement 318. Alternatively, the total number of impressions may include a count of only some actions made by audience members and/or only actions made by particular audience members. An audience member may “click-through” an advertisement 318. A click-through may be the process of clicking through an advertisement 318 to the advertiser's destination. In addition to or instead of a click-through, an audience member may choose to type a company's URL directly into the browser bar, or type the company's name into a search engine box.

Audience members may indicate an interest in the proposed future item. Interest in the proposed future item may be indicated by, for example and without limitation, by obtaining forward rights and/or obligations to the content. Forward rights and/or obligations may be obtained, for example and without limitation, by email, telephone call, instant message, page, website submission, or the like. If no forward rights and/or obligations are received, the impression count may be incremented. If forward rights and/or obligations are obtained, the forward right and/or obligation count and impression count may be incremented. In any case, additional input may be received and processed similarly. The creation of the future item may be contingent on reaching a threshold number of audience members indicating an interest in the future item. Alternatively, creation of the user content may be contingent on a threshold number of impressions made by audience members. Alternatively, creation of the future item may be contingent on a threshold combination of the number of indications of interest and impressions. Impressions may be valued less than an indication of interest in determining if a threshold has been reached. For example and without limitation, an impression may be valued at a fourth of the value of a forward right and/or obligation. If a threshold is reached, the future item may be created. Advertising revenue may be collected or paid out if future item is created or even if a threshold is not reached.

Advertising revenue may be generated by each impression, a group of impressions, a click-through, a group of click-throughs, or some combination thereof. A click-through may generate more revenue than an impression. The value of an impression may be a fraction of the value of a click-through in determining advertising revenue. The advertisement 318 may implement or be associated with referral fees. If an audience member ultimately purchases or uses the goods or services advertised in the advertisement 318, a referral fee may be paid to the user. If an advertisement 318 is forwarded to a member of a social network by an audience member and the social network user may ultimately purchase or use the goods or services advertised in the advertisement 318, a referral fee may be paid to the user and the audience member. The referral fee paid to an audience member may be less than the referral fee paid to a user.

For the purpose of illustration and not limitation, an example application of the present invention that provides user driven advertising and future item creation follows: A user may make a proposal to write a fictional book based on a recent gubernatorial race to a social network consisting of 1,000,000 audience members. The user may then associate an advertisement 318 related to an LCD high-definition television with the proposal. The user may also provide an endorsement of the television, such as and without limitation, “This is the best LCD high-definition television I have ever seen. I own one myself!” The proposal, advertisement, and endorsement may be sent by email to the audience members. If all 1,000,000 of the audience members view the future item proposition and the associated advertisement 318, then 1,000,000 impressions may be counted. These impressions may count towards reaching a threshold for future item creation. These impressions may also be valued in order to generate advertising revenue. For example and without limitation, impressions may be valued at $11.50 per 1,000 impressions. Thus, the impressions may generate $11,500 in advertising revenue. If 50% of the audience members click-through the advertisement 318, 500,000 click-throughs may be counted. These click-throughs may be valued in order to generate advertising revenue. For example and without limitation, click-throughs may be valued at $50.00 per 1,000 click-throughs. Thus, the click-throughs may generate an additional $25,000 in advertising revenue. If 10% of the audience members purchase the advertised television, the user may be eligible to receive referral fees. Referrals may be valued at $2.00 per referral. Thus, the referrals may generate $200,000 in referral fees. Advertising revenue and referral fees may be generated regardless of whether the user ever creates or becomes obligated to produce the content.

Continuing with the illustrative example of the preceding paragraph, the user may become obligated to create the content when a sufficient number of advance forward rights and/or obligations are received—say, a threshold of 10,000 advance forward rights and/or obligations. Thus, the user's proposed book may be referred to as “contingent content” to indicate that the user's commitment or obligation to creating the content may be contingent upon something. If 0.5% of audience members who viewed the future item proposition and the associated advertisement 318 actually obtain a forward right and/or obligation for content, then 5,000 forward rights and/or obligations for the book may be counted. In this example the threshold is 10,000 forward rights and/or obligations and, therefore, the user may not be obligated to create the content and the content may not proceed to production. However, the user may elect to create the content even though the threshold is not reached. This election may or may not obligate holders of the forward rights and/or obligations to purchase the book once it is published. Furthermore, in some embodiments impressions may be valued as equivalent to a fraction—say, 1/100—of a forward right and/or obligation. In other words, embodiments may capture the notion of there being some chance that an impression that does not result in a forward right and/or obligation will nevertheless lead to a book sale later, if and when the book becomes available for sale. In this case, the 1,000,000 impressions may be valued as 10,000 additional forward rights and/or obligations or forward rights equivalents. With 5,000 actual forward rights plus 10,000 forward rights and/or obligations equivalents, the threshold of 10,000 forward rights and/or obligations is exceeded and the user may be committed or obligated to produce the future item.

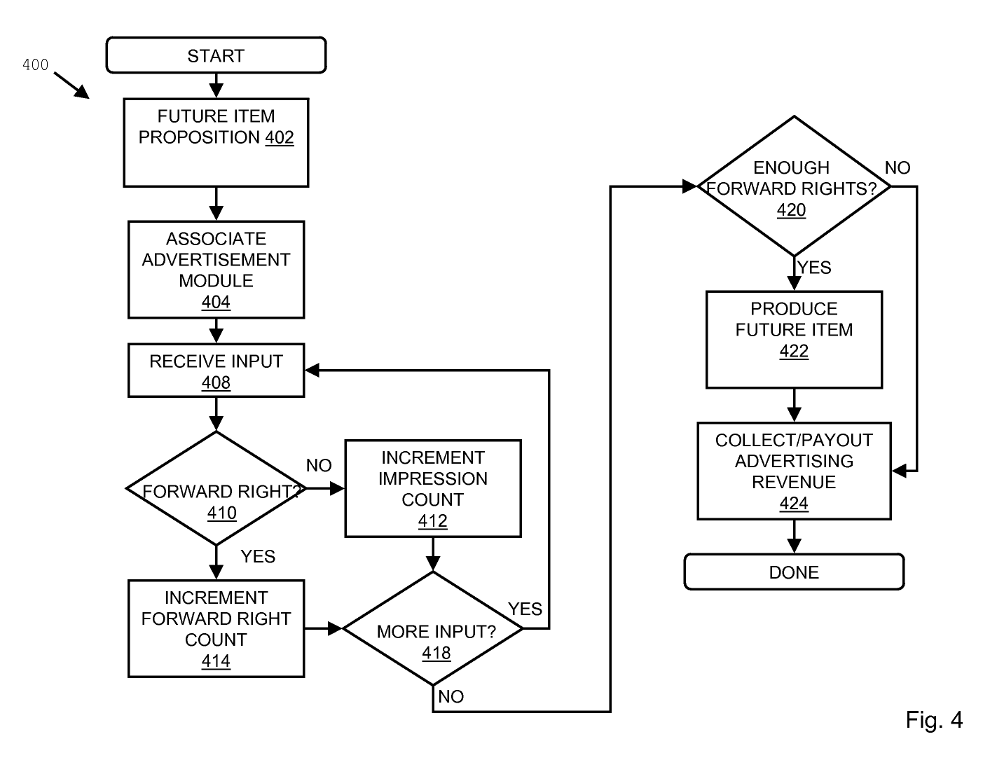

Referring to FIG. 4, an aspect of the invention may involve a process 400 for future item creation and user driven advertising. Starting at logical block 402, a future item proposition 304 may be made. Processing flow may continue to logical block 404 where an advertisement module may be associated with the offer. Processing flow may continue to logical block 408 where an input may be received 408. As indicated by logical block 410, a test may determine whether or not forward rights and/or obligations may be obtained. Continuing to refer to logical block 410, if forward rights and/or obligations have not been obtained, the input is counted as an impression and the impression count is incremented 412. Processing flow may continue to logical block 418 where a test may determine if there is additional input 418. If the test at logical block 410 is positive, processing flow may continue to logical block 414 where the forward rights and/or obligations count may be incremented 414. Processing flow then continues to logical block 418. If there is additional input, processing flow returns to logical block 408. If there is no additional input, processing flow continues to logical block 420 where a test may determine if enough forward rights and/or obligations 420 have been counted. If enough forward rights have been obtained, the future item may be produced 422. Processing flow may continue to logical block 424 where advertising revenue is collected or paid out 424. If enough forward rights and/or obligations have not been obtained, processing flow may continue to logical block 424. In any case, logical flow may terminate upon reaching logical block 424.

Referring now to FIGS. 5 and 6, other elements that may be resident along with the modules, processes, steps, methods, and systems described herein may be depicted. A trading marketplace 502 for a contingent event certificate or right and/or obligation (“CEC”) 606 may enable a consumer 542 or producer 668 to participate, through a host platform 660, in the acquisition or generation of a future item 624 and to obtain or offer forward rights 640 and/or forward obligations 648 associated with the future item 624 and, in embodiments, wherein the forward right 640 and/or forward obligation 648 is associated with aggregation of sufficient demand for the future item 624. CECs 606 may be provided on a trading marketplace 502. CECs 606 may be provided in a pre-forward market, such as an offering of a CEC 606 to a portion of potential consumers 542 or producers 668 prior to an offering of the CEC 606 to a wide audience. During the pre-forward market, the future item 624 may be pre- pre sold. CECs 606 may be provided in a forward market, such as an offering of a CEC 606 to a wide audience of potential consumers 542 or producers 668. During a forward market, the future item 624 may be pre-sold. CECs may be offered in a primary market, such as a determined right to a future item. During a primary market, a future item 624 may be built, produced, delivered, and the like. CECs 606 may be offered in a secondary market. During a secondary market, CECs 606 may be re-sold, traded, and the like. A CEC 606 may be offered for future items 624, such as those related to sports 572, travel 574, music 578, games 580, consumer products 582, books 584, services 588, and the like. A CEC 606 may be offered for a dream product, service, event, offering, and the like. For example, a user may want to see U2 play with The Police and will create a CEC 606 proposal for this event. The user may ask other to vote on the proposal so that demand for the event may be gauged. If the contingency that the two artists play together is resolved, the user may be rewarded with a CEC 606, may have an opportunity to purchases CECs 606 before others or at a lower cost, and the like. In an embodiment, the user may reap no additional benefits.

There may be attributes or contingencies associated with the future item 624. For example, an attribute or contingency 514 of a CEC 606 may be that it is offered for a specific team in a sports 572 future item 624. In another example, an attribute of a CEC 606 may be that it is offered for a specific kind of future item 624, such as an event ticket, a book, a digital download, and the like. In another example, a contingency or attribute 644 of the CEC 606 may be its expiration after a certain date. In another example, a contingency or attribute 514 may be the location of the future item 624 associated with the CEC 606. In another example, the contingency or attribute 514 may be how a contingency may be resolved, such as due to an aspect of demand aggregation, the weather, a team standing, and the like.

The CEC 606 may associate forward rights 640 and/or forward obligations 648 with the future item 624. Forward rights 640, for example, may be the right of a CEC 606 holder to purchase or obtain a future item 624, such as consumer product, a consumer service, an event ticket, and the like. Forward obligations 648 may be an obligation on behalf of a CEC 606 holder to purchase or obtain a future item 624, such as consumer product, a consumer service, an event ticket, and the like. In some embodiments, the CEC 606 may comprise a forward right 640, a forward obligation 648, or both. In any event, forward rights 640 and forward obligations 648 associated with a future item 624 may be contingent on an occurrence or outcome, such as the aggregation of sufficient demand for the future item 624. In some embodiments, forward rights 640 and forward obligations 648 associated with a future item 624 may not be contingent on an occurrence or outcome, such as for a determined right to a future item 624. For example, a retailer of an extremely popular gaming system may offer consumers 542 or producers 668 of the trading marketplace 502 the opportunity to reserve the second generation of the gaming system prior to its eagerly anticipated release. In this case, the CEC 606 offers the CEC 606 holder the forward right 640 to purchase the gaming system once it is released without having to worry about the demand and supply issues that would certainly plague conventional consumers of the high demand gaming system. The retailer may or may not additionally associate a future obligation 648 to purchase with the forward right 640. In this example, there may not be a contingency associated with the future item 624 other than the actual product launch as the item may already be in development and there may already be plans to retail the item. In some embodiments, a future obligation 648 may be associated with a future item 624, such as a future purchase obligation, even if the face value of the future item 624 is not yet known. For example, there may be a different face value price for a future item 624 offered to an early adopter, such as a participant in a pre-forward market, versus the price offered to a late adopter, such as a participant in a forward market. In such a scenario, as well as in others that can be readily appreciated by one skilled in the art, the lack of a face value during the forward market may serve as an incentive.

Forward rights 640 may be one-sided or two-sided. For example, a forward right 640 may be granted to a CEC 606 holder to purchase the second generation of a gaming system from a retailer. The forward right 640 is one-sided as only the CEC 606 holder has rights and the retailer must provide the second generation gaming system for purchase to the CEC 606 holder. A forward right 640 may also be granted as a two-sided right. For example, a consumer 542 may be granted a forward right 640 by the retailer in the one-sided rights example above in exchange not for money but for the right to access the consumer 542 for surveys and opinion polls.

Forward rights 640 may be long or short. For example, an offeror of a CEC 606 may have access to the future item 624, such as by owning it, being a distributor or retailer it, being the producer, and the like. Thus, the offeror may have a long position in the future item 624. In some embodiments, the offeror may have a short position in a future item 624, such as when they do not have access to the future item 624 and are simply taking advantage of the opportunity that a contingency may not be met so that the CEC 606 will vest or mature and they will not have to fulfill the CEC 606 by providing the future item 624. In any event, the offeror may be obligated to provide the future item 624 regardless of whether they had access to the future item 624 at the time of offering forward rights 640 to the future item 624.

Forward rights 640 and/or forward obligations 648 may be paid, earned, not paid, and the like. For example, a consumer 542 or producers 668 may participate in a loyalty program with an electronics retailer that may allow them to earn points towards a forward right 640 and/or obligation 648. In the example, a consumer 542 or producers 668 may earn points by obtaining a credit or charge card with the retailer, making purchases from the retailer, making accessory purchases directly related to a future item 624, and the like.

The trading marketplace 502 may be hosted on a host platform 660. The host platform 660 may comprise algorithms 520 such as for pricing methods 654 and staging methods 524, interfaces 528 such as a consumer user interface 530 and a producer user interface 532, and a data facility 534 such as for demand aggregation 622 and trade data 540.

Pricing methods 654 may be used to set a price for a forward right 640 or obligation 648 to a future item 624. Pricing methods 654 may be based on the marketplace. For example, the price may be set initially in a Dutch auction, such as by progressively lowering the price from a high starting point until a participant is willing to accept the price. In another example, the price of forward rights 640 for a future item may be established using pricing methods 654 that are based on power rankings. For example, the price of a forward rights 640 to an NFL game may be based on the power rankings of NFL teams. In another example, pricing of a forward right 640 or obligation 648 may be based on a previous forward market.

In an embodiment, consumers 542 may use a consumer user interface 530 to access the trading marketplace 502. The consumer user interface 530 may be accessed by the web, email, phone, wireless device, television, referrals, and the like. In an embodiment, consumers 542 may be public 544, private 550, individuals 548, groups 552, and the like.

In an embodiment, producers 668 may use a producer user interface 668 to access the trading marketplace 502. The producer user interface 668 may be accessed by the web, email, phone, wireless device, television, referrals, and the like. In an embodiment, producers 668 may be rights holders 558, manufacturers and retailers 560, users 562, and the like. Users 562 may be groups 564, social networks 568, individuals 570, and the like.

Referring now to FIG. 6, an advertisement or promotion 602, further described in Harmon 3 and/or Cella, may include any form of advertisement or promotion 602. For example, in one embodiment of the invention, credits from music downloads may be used for promotional programs such as a sponsor program. Rather than access rights being a feature of who gets to the front of the line, or who ends up getting through on the phone at Ticketmaster, in accordance with the present invention access may be earned, such as through a loyalty program. The advertisement or promotion 602 may alternatively or additionally be described in Cella. Thus, in another embodiment, knowing that a skier might arrive based on a weather contingency, a vendor could target advertising for a host of related products and services, even if the skier doesn't end up purchasing the package.

An alternative right/benefit 604, as further disclosed in Harmon 3, may include a wide range of alternative benefits, such as when users accumulate credits that can be applied toward a purchase of a product or toward purchase of a ticket or entry to an event if it were to be certain.

The contingent aspect 608 of a contingent event certificate 606 or right may, without limitation, be described within or throughout any and all of the documents incorporated by reference herein herein. This contingency may be associated with a team 610, as described in Cella. For example, among many possibilities, options could be made exercisable based only on the presence of a buyer's designated team in the Super Bowl. A contingency may be associated with a player 621. For example, a fan could purchase a right for a ticket to a particular game if that player was to appear in the game. This contingency may be associated with a venue 614, as described in Harmon 6. For example, contingent event ticket certificates for various events may in the future be scheduled to take place at a designated venue 614. A contingency may be associated with a location 618, as described in Harmon 3. For example, a band may or may not end up playing a given town (that is, rights may be for a specific music event in a given town). A contingency may be associated with weather 620. For example, vendors may offer the same item to different individuals, depending on different tastes for weather-related goods and services. A ski package could be contingent on the presence of snow, for example. In another example, a user may purchase a contingent event certificate for travel contingent upon weather wherein the contingency is if there is snow, the travel is to a ski resort and if there is rain or insufficient snow, travel is to a beach. A contingency may be associated with demand 622 for a future item, as described in Harmon 1. For example, a toy manufacturer may create contingent event certificates 606 for several different lines of toys. Based on demand 622 as determined at least by the number of contingent event certificates 606 sold on a primary market, the toys may be released in time for the holidays. The toy manufacturer may decide to produce certain toys in different quantities (or not at all) based on the demonstrated demand levels. Alternatively, the toy manufacturer may issue a limited number of contingent event certificates 606 for the toys that would entitle and obligate a holder of the contingent event certificate 606 to purchase a first production run of the toy. In this way, the holder of a contingent event certificate 606 would be assured to be able to purchase the toy at a fixed price if the toy is produced. In addition, the toy manufacturer can size the first production run appropriately to ensure every contingent event certificate 606 holder can purchase the toy.

The future item aspect 624 of a contingent event certificate 606 or right may, without limitation, be described within or throughout any and all of the documents incorporated by reference herein herein. The future item 624 may be associated with sports 628, as described in Harmon 6 and/or Harmon 1. Contingent event ticket certificates 606 may be for various events, such as sporting events. In embodiments, sports fans may themselves be allowed to define a market. For example, a fan may want to see Manchester United play the Spanish National team in the new Miami stadium in 2007. Once this new market is created, a plurality of sports fans (that is, consumers) may purchase the initial allotment and/or trade the contingent event certificates 606. Alternatively or additionally, the future item 624 may be associated with particular contingent combinations associated with sports 628, as described throughout Cella. For example, the participant-event for which an options or futures contract for tickets and/or accommodations may be purchased may be a team-game, team-round, or team-round-game. The future item 624 may be associated with music 630, as described in Harmon 3. For example, advanced music access rights may be created for any unique, recurring or one-time event where the possibility of the event occurring is not assured. Concerts, festivals, operas and any other type of domestic or international music or entertainment events may be contingent events. The future item 624 may be associated with travel 632, as described in Cella. For example, a buyer could purchase an option to purchase a vacation package to a Caribbean island, contingent on the absence of any hurricanes in the Atlantic Ocean one week before the date of departure. The future item 624 may be associated with an accommodation, as described in Cella. For example, a buyer could purchase an option of having a hotel room in a particular city contingent on a particular event occurring in that city, such as a concert, playoff game, political convention, and the like. In another example, a buyer could purchase the option of having a restaurant reservation at a 4-star restaurant contingent upon an event occurring near the restaurant, such as a sporting event, concert, convention, and the like. The future item 624 may be associated with transportation, as described in Cella. For example, a buyer may purchase the option of a flight to a city contingent upon an event occurring in the city, such as a sporting event, concert, convention, and the like. Transportation may include flights, chartered flights, chauffeured limousines, rental cars, trains, buses, yachts, and the like. The future item 624 may be associated with a product launch 634, as described in Harmon 1. For example, a product designer may have a concept for a new type of home appliance. The product designer may offer contingent event certificates 606 that both entitle and obligate the holder to purchase the home appliance. Through promotion of the appliance, demand 622 may be generated based on a description, virtual model, prototype, review, et cetera of the home appliance. The promotion may include information about the offered contingent event certificates 606. The demand 622 resulting from both direct and indirect promotion of the appliance may be assessed by a count of contingent event certificates 606 sold on the pre-primary market. The product designer may use the demand measure to establish contingent agreements for production, distribution, sales, advertising, and support of the appliance. Production may commence once demand 622 reaches a minimum level that may be selected to reduce or eliminate the risk of financial failure. While this example is for a home appliance, the product launch could be for any type of product or service such as a movie, a game, a toy, a book, a composition of music, lawn care service, insurance product, and the like. It will be appreciated that contingent event certificates 606 offered through a pre-primary market can be used to assess the viability of any and all new products or service creations.

The certificate 606 aspect of a contingent event certificate 606 or right may, without limitation, be described within or throughout any and all of the documents incorporated by reference herein herein. The certificate 606 may be associated with forward rights 640, as described in Cella. For example, disclosed herein is a system for allowing a remote user to purchase, over a distributed computer network (e.g., the Internet), an option to purchase a ticket, goods or services, or other item that is based on a contingent event. The certificate 606 may be associated with a reward 642, as described in Harmon 2. For example, in one embodiment, businesses can reward employees with contingent event certificates 606 if a set standard or goal is achieved. It will be appreciated that a certificate 606 may be tradable (or non-tradable) 605, refundable, purchasable, and so on. It will also be appreciated that a certificate may encompass rights, obligations, and/or the like 648. The rights and/or obligations that the certificate 606 encompasses may mature, vest, convert, expire, et cetera. For example and without limitation, the rights and/or obligations may vest as a reward 642 that occurs in response to an occurrence of a predetermined event. The certificate 606 may encompass associated access 644 to something, as described in Harmon 1. For example, each contingent event ticket certificate may correspond to a particular seat within a venue 614. In the case of a personal seat license (PSL), a typical PSL grants the licensee the right to purchase season tickets for a particular seat in the venue 614 every season. A contingent access rights exchange provides a mechanism whereby individuals holding inventory in the form of PSLs may post offers to sell some or all of their holdings, such as subject to a contingency. In other embodiments travel or ski packages (travel, hotel, lift tickets, etc) for spring skiing trips may be optioned.

Harmon 1 relates to a market for trading permanent seat licenses (PSLs), individual event tickets, and contingent event ticket certificates for various events, such as sporting events, concerts, and the like which are scheduled to take place, or may in the future be scheduled to take place at a designated venue. The invention provides both a method of trading such products and an electronic exchange for facilitating such trades.

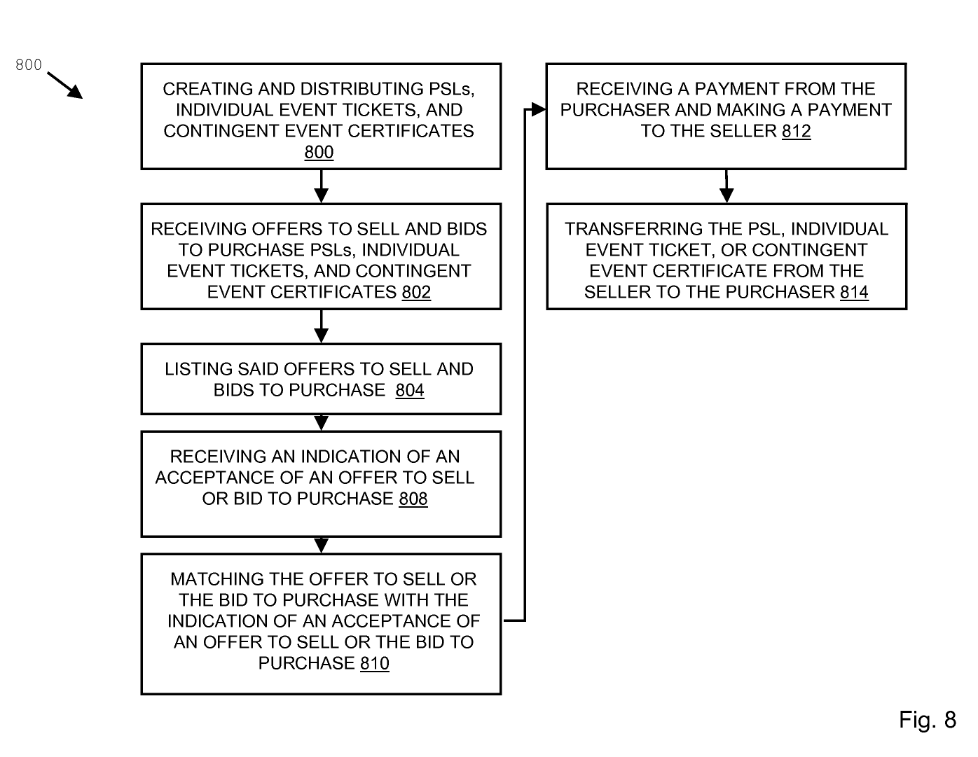

Referring now to FIG. 8, a method is disclosed for trading PSLs, event tickets and contingent event ticket certificates. Step 800 calls for creating and distributing an inventory of PSLs, individual event tickets, and contingent event ticket certificates. Contingent event tickets are a novel product created in accordance with the present invention. A contingent event ticket certificate represents the right and obligation to purchase an event ticket at face value for an event that may (or may not) be scheduled in the future. According to an embodiment of the invention, whoever is the holder of record of a contingent event ticket certificate when the contingent event is scheduled and tickets for the event go on sale is automatically billed for the face value of the ticket. If the contingent event ticket certificate holder has agreed to pay by credit card, the designated credit card account is automatically charged. In order to facilitate electronic trading of PSLs, event tickets, and contingent event ticket certificates, it is preferred that the initial distribution of tickets and contingent event ticket certificates is performed electronically so that a database may be maintained of all tickets and contingent event ticket certificates in the inventory, the current owner of each ticket or contingent event ticket certificate, and an audit trail of all previous owners going back to the ticket's or contingent event ticket's creation. Also in the interest of facilitating electronic trading of PSLs, event tickets and contingent event ticket certificates and maintaining accurate ownership records of such products, it is further preferred that only tickets associated with PSLs are traded on the exchange.

Since each PSL, ticket, and contingent event ticket certificate corresponds to a particular seat within a venue, it is possible to group PSLs, tickets, and contingent event certificates into zones or sections having similar viewing characteristics. A person using the present inventive method or electronic exchange to purchase a ticket may specify a zone in which he or she wishes to purchase a ticket. A ticket for any seat within the specified zone will satisfy a purchase request for a ticket within the specified zone.

Once the PSL, ticket, and contingent event ticket certificate inventory has been distributed, step 802 involves receiving offers to sell and bids to purchase PSLs, event tickets and contingent event ticket certificates. In an embodiment of the invention transactions are settled in real time. Only the actual holders of inventory (PSLs, tickets, and contingent event ticket certificates) can place offers for sale, while any member of the exchange can place bids to purchase. However, other trading rules are possible where a party not holding inventory may be allowed to offer PSLs, tickets or contingent event ticket certificates for sale as long as he or she makes good delivery of the sold products at a specified time and in a specified manner.

Step 804 calls for listing the received offers to sell and bids to purchase inventory. In order to limit confusion and increase the efficiency of the market, not every offer and bid need be displayed. For example, the current market rate for PSLs, tickets or contingent event ticket certificates may be quickly surmised from the best bid and best offer for a particular zone. The most recent transaction for a PSL, ticket or contingent ticket in a given zone may also give further guidance as to the current market price.

Step 808 involves receiving an indication either from a purchaser indicating that he or she accepts one of the listed offers to sell, or from a seller indicating that he or she accepts one of the listed bids to purchase. The party who posted the accepted bid or offer is matched to the party who indicated an acceptance of the bid or offer in step 810. A payment is received from the purchaser and a payment is made to the seller in step 812. Finally, the inventory that is the subject of the transaction, be it a PSL, an individual event ticket (or tickets), or a contingent event ticket certificate (or certificates), is transferred from the seller to the purchaser in step 814.

In addition to the method of trading PSLs, individual event tickets, and contingent event tickets just described, the present invention further encompasses an exchange for trading PSLs, event tickets and contingent event ticket certificates according to the method just described, such as the herein described exchange 232, trading marketplace 502 and contingent event certificate or rights market 682, 900.

Buyers approach the exchange with no inventory but with cash in hand to make purchases. The buyers may post bids to purchase inventory on the exchange. Typically such a posting would include a description of the inventory the buyer wishes to purchase and the amount the buyer is offering to pay. For example, a buyer may post a bid for four zone 18 tickets for an August 10 doubleheader, offering to pay $20.00 per ticket. The seller's offer to sell the tickets at $40.00 and the buyer's bid to purchase the tickets at $20.00 are listed on the exchange and are visible to all participants in the exchange, both buyer and sellers. Thus, a market price is established somewhere between $20.00 and $40.00 per ticket for a set of four tickets in zone 18 for the August 10 double header between Team A and Team B.

In addition to listing their inventory for sale at a specific price above the current market price, sellers may alternatively chose to accept a buyers' bid to purchase tickets at the buyer's bid price. So, for example, if a seller sees a buyer's $20.00 bid and decides that it is close enough to what he or she willing to accept for the tickets, the seller may accept the offer. Of course, other sellers who may also have inventory equivalent to that being offered by the first seller (i.e., four tickets in zone 18 for the August 10 doubleheader between Team A and Team B), may under cut the first seller's original $40.00 offering price by either offering to sell their inventory at a lower price, or by accepting a buyer's lower bid price.

A similar process is at work on the buyers side of the exchange. Buyers may place bids to purchase tickets at prices below those currently offered by the sellers, or buyers may accept sellers listed offers. If a buyer sees a seller's $40.00 per ticket offer and decides that her or she is willing to pay that amount to attend the event, the buyer may accept the seller's offer. Of course, other buyers may also want to attend the August 10 doubleheader and beat the first buyer to the punch by either accepting the first seller's $40.00 per ticket offer, or by posting a bid for four zone 18 tickets at a price higher than the $20.00 per ticket offered by the first buyer.

Once an offer or bid is accepted the exchange matches the buyer with the seller. Preferably this function is transparent to the parties using the exchange. The buyer and seller deal only with the exchange, never directly with one another. The exchange receives a payment from the purchaser in at least the amount agreed upon in the transaction (an additional transaction servicing fee may also be required to support the exchange). Likewise, the exchange may make payment to the seller in an amount up to the price agreed upon the transaction. (Again, a transaction servicing fee may be required, and the seller's payment reduced accordingly.) To complete the transaction the inventory being sold must be delivered from the seller to the exchange and from the exchange to the purchaser.

As will be described more fully below, an embodiment of an exchange according to the present invention may be completely electronic. PSLs, event tickets, and contingent event ticket certificates along with ownership records, and the records of exchange participants, and provisions for making and receiving payment are all stored on a database. In this embodiment the act of physically delivering the inventory to the exchange and from the exchange to the purchaser is not required. Nor are the steps on making and receiving payments. Instead, the ownership records of the inventory records are changed to reflect the new owner, and credit card accounts may be charged for payment and credited for sales.

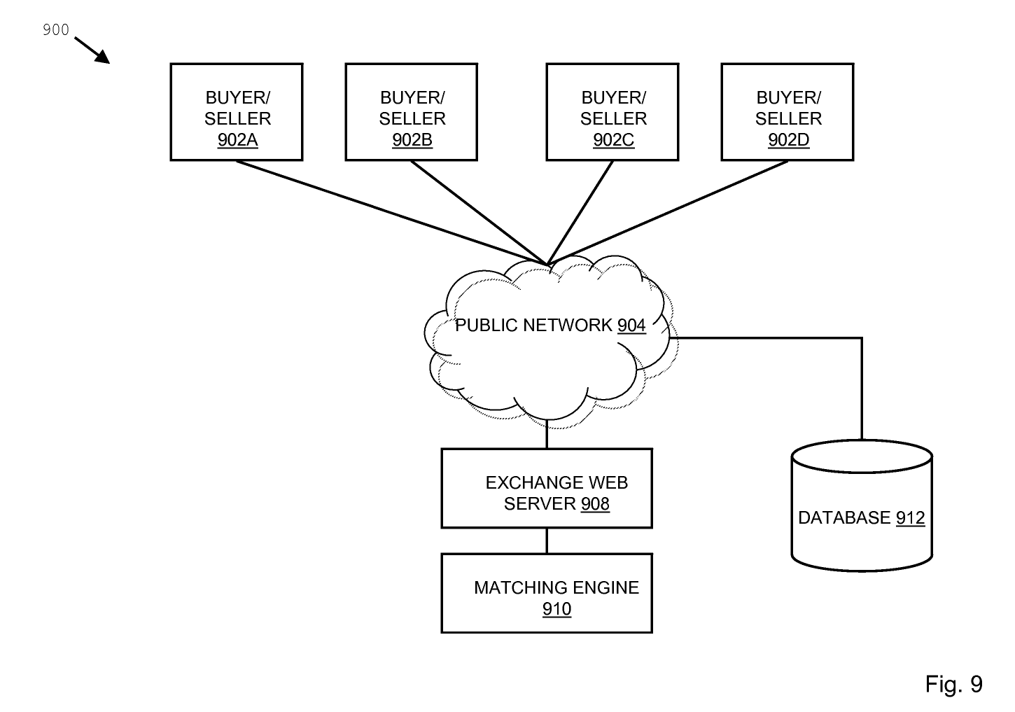

FIG. 9 shows a block diagram of a network-based exchange for trading PSLs, individual event tickets, and contingent event ticket certificates according to an embodiment of the invention. The exchange 900 includes a number of user terminals 902a, 920b, 902c . . . 902n linked to a ticket exchange web server 908 via a public network 904 such as the World Wide Web. Web server 908, in addition to being connected to public network 904 is functionally connected to exchange software 910 for matching offers and bids with indications of accepting offers and bids, and a database 912 which maintain records of PSLs, tickets and contingent event ticket certificates, who owns them, and how they are traded.

According to an embodiment of the invention only tickets associated with PSLs may be traded on the network-based exchange 56. In this embodiment the tickets associated with the PSLs are wholly creatures of the virtual exchange environment. When an individual purchases a PSL (preferably through the exchange after having registered with the exchange) a record is created in the database 912. If the PSL is not purchased through the exchange, a record of the PSL must be created and stored in the exchange database. When the licensee purchases his or her season tickets each season according to his or her rights under the PSL, the database is updated to reflect this additional inventory. Each individual ticket for each scheduled event is represented in the database and a record of its current owner (initially the PSL licensee) is also stored.

Individuals who do not own PSLs, but who are interested in purchasing tickets on the exchange must first register with the exchange. A database record is created for each registered member of the exchange. As registered customers and inventory holders make purchases and sales, their records are updated to reflect their newly acquired or depleted inventory. Furthermore, a record of each transaction is recorded each time inventory changes hands. Thus, each PSL, event ticket or contingent event ticket certificate will have a complete audit history associated with it so that each owner and each transaction can be identified at a later time. Like PSL owners, customers who have purchased inventory on the exchange may also trade their holdings. Thus, a “ticket” may change hands (virtually) several times before it is finally printed and actually used to gain access to an event.

Contingent event ticket certificates may be treated in a similar manner, or they can be distributed entirely independently of PSLs. In a first alternative, contingent event ticket certificates are created with the season ticket packages purchased by the PSL licensees each season. Thus, in the arrangement the PSL owner is the owner of record for all contingent event ticket certificates associated with the licensed seat at the beginning of each season. For example, a PSL licensee having a license to purchase season tickets for a baseball team's home games would also obtain 11 contingent event ticket certificates, three for the Divisional Playoff series games (assuming a best of 5 series), four for the League Championship series and four for the World Series, assuming a best of 7 format for the league championship series and world series. These are the maximum number of possible post season home games if the team enjoys home field advantage in each series and each series extends to the maximum number of games. Of course, the actual number of contingent events scheduled at the team's home venue may actually be much less than 11 depending on the team's performance.

Another alternative for initial distribution of contingent event ticket certificates is to offer PSL licensees a right of first refusal to purchase contingent event ticket certificates. If the PSL licensee does not exercise his or her right to purchase the corresponding contingent event ticket certificates, they may be offered for sale to the highest bidders in an on-line auction conducted on the exchange 900.

Finally, contingent event ticket certificates may be offered directly to all registered members of the exchange 900. According to this alternative, contingent event tickets are offered in an open auction. Bidding may be scheduled for a set period of time and the member offering the highest bid at the close of bidding is awarded the contingent event ticket certificate for which he or she is bidding in exchange for the winning bid price.

A note should be made here regarding the payment mechanisms for contingent event ticket certificates. Obviously, if the contingent event ticket certificates are included in the season ticket packages of PSL licensees, the PSL licensee may be charged for the contingent event ticket certificates when he or she pays for his or her season tickets. The same is true if the PSL licensees are offered a right of first refusal to purchase the contingent event ticket certificates. In the open auction model, however, since members of the exchange may be required to submit a valid credit card number to join the exchange, the credit card account of the highest bidder may be automatically charged the bid amount immediately upon the close of bidding. The purchasing member's inventory record may then be updated to reflect the newly purchase contingent event ticket certificate.

A similar automatic credit card transaction can be established to take place when contingent event ticket certificates mature into actual event tickets, such as when a team becomes eligible for post season play. Typically an announcement will be made as to when post season event tickets (playoff or championship series games and the like) will go on sale. This date, or some other arbitrary date, can be established as the date on which contingent event ticket certificates for a contingent event which is subsequently scheduled mature into actual event tickets for the newly scheduled event. Whoever is the holder of a contingent event ticket certificate on the specified date is charged the face value of the newly scheduled event ticket. Likewise, the inventory record of the owner of the contingent event ticket certificate will be updated to reflect that he or she then owns an actual event ticket rather than a contingent event ticket certificate.

Referring again to FIGS. 5 and 6, the certificate 606 may be associated with a right and obligation 648, as described in Harmon 6. For example, a contingent event ticket certificate 606 may represent the right and obligation to purchase an event ticket at face value for an event that may (or may not) be scheduled in the future. The certificate 606 may be tradable 650, as described in Harmon 1. The certificate 606 may be digital 652, as respectively described in Harmon 6 and Harmon 1. For example, in order to facilitate electronic trading of contingent event certificates 606, it is preferred that the initial distribution of contingent event certificates 606 is performed electronically. The act of physically delivering the inventory to the exchange and from the exchange to the purchaser is not required. Nor are the steps of making and receiving payments. Instead, the ownership records of the inventory records are changed to reflect the new owner, and financial accounts may be charged and credited for purchases and sales accordingly.

Pricing 654 that is associated with a contingent event certificate 606 or right may, without limitation, be described within or throughout any and all of the documents incorporated by reference herein herein. At least one example of this is provided in Harmon 1, where it is noted that the current market rate for contingent event certificates 606 may be quickly surmised from the best bid and best offer for a particular zone of a ballpark.

A contingent event certificate (or rights) market 682 may be associated with a platform 658, which may, without limitation, be described within or throughout any and all of the documents incorporated by reference herein herein. The platform 658 may be associated with a host 660. The platform 658 may be associated with fulfillment 662, which may be electronic (as described hereinabove with reference to a digital 652 certificate 606) or physical.

Participants 600 may comprise providers or suppliers 664, such as and without limitation producers 668, as generally described in Harmon 6. For example, a merchant supplier may be the party that offers to produce a particular consumer product item in the event a demand threshold is obtained through the sale of forward rights.

Participants 600 may comprise related/integrated markets 670, which may be described within or throughout any and all of the documents incorporated by reference herein herein. The markets 670 may comprise a secondary contingent event certificates or rights market 672. For example, in embodiments a neutral third party may centralize market-related data and provide a marketplace where access rights can be liquid. In embodiments the present invention further encompasses an exchange for trading contingent event ticket certificates. In a preferred embodiment of the invention the exchange holds the inventory of items being traded. The items being traded may be intangible items such as contingent event certificates 606. The markets 670 may comprise a rights market 674, as described in Harmon 3. For example, credits may convert to a ticket or “full forward” right that is liquid and tradable on the rights market 674. Since full rights can be traded, a market could be run well in advance of the anticipated future item. The markets 670 may comprise a rights resale market 678, as respectively described in Harmon 6. For example, once a PSL, ticket, or contingent event ticket certificate inventory has been distributed, embodiments of the present invention involve receiving offers to sell and bids to purchase PSLs, event tickets and contingent event ticket certificates. In an embodiment of the invention transactions are settled in real time. In a preferred embodiment of the invention the exchange holds the inventory of items being traded. The items being traded may be intangible items such as event tickets, or simply access rights. The markets 670 may comprise a primary contingent event certificate or right market 682, such as involving a method for trading contingent event certificates 606.

The platform 658 may be associated with a user interface 619 for communication with consumers.

A contingent event certificate 606 or right may be combined 688 with one or more other contingent event certificates 606 or rights in a contingent event market platform. Combining 688 contingent event certificates 606 or rights may facilitate providing access to a future item for a plurality of contingent event certificate 606 or right holders. A combination of contingent event certificates 606 or rights may facilitate improving the chances that a holder of the combined contingent event certificates 606 or rights will remain obligated to exercise one of the contingent event certificates 606 or rights. Contingent event certificates 606 or rights may be combined 688 such that a failure of one contingent event certificate 606 or right may be the contingency required for a second contingent event certificate 606 or right to mature.

Contingent event certificates 606 or rights may be combined 688 such that the holder or holders of the combined contingent event certificates 606 or rights may exchange the certificate at a reduced cost. This may be compared to purchasing a single ticket versus purchasing a “group rate” quantity of tickets. The single ticket may be more costly than one of the group rate tickets because the purchaser of the group rate ticket is obligated to purchase a minimum number of tickets. Contingent event certificates 606 or rights may be combined 688 to form a group that may qualify for a group rate cost. To illustrate this, an exercise cost for a single mature (contingency met) contingent event certificate 606 or right may be $100 whereas a combination of contingent event certificates 606 or rights may result in a cost to exercise each contingent event certificate 606 or right in the combination that may be $85. The contingencies for each contingent event certificate 606 or right in the combination may be the same, such that all of the combined contingent event certificates 606 or rights mature together.

Contingent event certificates 606 or rights may be combined to facilitate improving the chances that at least one of the combined contingent event certificates 606 or rights will mature and be exercised. This may be beneficial to a holder of combined contingent event certificates 606 or rights who wishes to improve the likelihood of attending an event, obtaining a consumer product, being offered a service, and the like. While the future item may be the same for each combined contingent event certificate 606 or right, the contingencies may be different. A combination of contingent event certificates 606 or rights may cover a plurality of contingencies such that if any of the contingencies is met, the holder may exercise the mature contingent event certificate 606 or right. For example, a combination of contingent event certificates 606 or rights may cover an event that is contingent upon weather conditions, such as an outdoor concert. The combination may include a contingent event certificate 606 or right that is contingent upon clear weather, another may be contingent on rain, and yet another may be contingent upon snow. The contingent event certificate 606 or right contingent on clear weather may include an open-air lawn seat. The contingent event certificate 606 or right contingent on rain may include a seat in a covered pavilion; and the contingent event certificate 606 or right contingent on snow may include an indoor seat in a heated building. This combination provides a variety of contingencies for one event.

The cost to exercise and/or the number of contingent event certificates 606 or rights available for each of the contingency may be different. For example and without limitation, the venue 614 may include X number of indoor seats each with an exercise price of $100, 4× pavilion seats each with an exercise price of $85, and 10× open air lawn seats each with an exercise price of $40.

A combination of contingent event certificates 606 or rights may be associated such that the failure to mature of one of the contingent event certificates 606 or rights in the combination becomes a contingency for another contingent event certificate 606 or right in the combination to mature. This allows a market maker of contingent event certificates 606 or rights for a future item to manage the total number of contingent event certificates 606 or rights to mature such that this number does not exceed the number of available seats. In our example the combination contingent event certificate 606 or right that is contingent on rain will not mature if the weather is clear, thereby only allowing the contingent event certificate 606 or right contingent on clear weather to mature. The holder of this combination contingent event certificate 606 or right may be obligated to purchase the open-air lawn seat.

An alternative combination of contingent event certificates 606 or rights may facilitate a holder of the combination to attend one of two or more contingent events. As an example, a combination of contingent event certificates 606 or rights for a Major League baseball playoff game may include a contingency based on the venue 614 in which the game is played. Continuing the example, a contingency for two contingent event certificates 606 or rights may be that a team, such as the Mets, participates in the playoff game. The first contingent event certificate 606 or right in the combination may also include a contingency that the game be played in the Mets home stadium, whereas the second contingent event certificate 606 or right in the combination may include a contingency that the game be played in the opponent's home stadium. A similar combination may include a first contingent event certificate 606 or right of the combination on the Mets playing the playoff game at home and the second contingent event certificate 606 or right of the combination may include a contingency that another team (the Yankees) plays in the playoff game at home. This combination may allow a holder to exercise only one of the combined contingent event certificates 606 or rights. The Yankees playoff game contingent event certificate 606 or right would not mature if the Mets playoff game contingent event certificate 606 or right matures. It should be appreciated that these combinations of contingent event certificates could apply to the previously disclosed broad range of forward rights to things well beyond live events such as consumer products, consumer services, and various forms of the arts such as movies. Many other such examples will be appreciated and all such examples are within the scope of the present disclosure.

An offering related to a contingent event certificate 606 or right may include disclosure of information 690 about the related offer only if the contingency matures. Withholding the information 690 about the related offering may facilitate increased flexibility of the provider of the related offer in fulfilling the related offer for a mature contingent event certificate 606 or right. An example includes an offer for hotel accommodations related to a contingent event certificate 606 or right. The related offering information 690 available prior to the contingent event certificate 606 or right maturing may be limited to a class of hotel, a geographic area, and the like. Upon maturing, the related offer provider may determine a specific hotel based at least in part on an aspect of an agreement to provide lodging the provider has made with one or more hotels in the class or geographic area.

A related offering may include a secondary contingency that must be met in addition to the contingent event certificate 606 or right contingency. As an example, the contingent event certificate 606 or right contingency may include a seat at a Mets home playoff game. The related offering may include a contingency that depends upon the holder of the mature contingent event certificate 606 or right providing information 690 such as personal information and/or demographics to the related offer provider to receive the related offering.

A contingent event certificate 606 or right may be combined 692 with other rights. The other rights may be associated with a future item. The other rights may be related in time with the future item. The other rights may facilitate the holder of the mature contingent event certificate 606 or right accessing a future item. In the example of an event, the rights may include one or more of parking privileges, transportation to the venue city, transportation to the venue, transportation to a hotel in the venue city, transportation (such as taxi, trolley, limousine, town car, bus, train, and any other mode of transportation) among two or more locations associated with the venue 614. The rights may include use of venue facilities, admittance to event associated parties, social network events, meet and greet with the participants of the event, and so on. The rights may include goods and services such as items associated with the event. The contingent event certificate 606 or right may be combined with rights related to lodging. For example, a holder of a mature contingent event certificate 606 or right may, in addition to purchasing a seat at the contingent event may also purchase a hotel room near the venue 614 at a predetermined price (such as a discounted price).

The contingent event certificate 606 or right may be combined 692 with other rights such as the right to sell the contingent event certificate 606 or right before or after maturing. The contingent event certificate 606 or right may be combined 692 with rights to purchase other contingent event certificates 606 or rights at a predetermined price. For example, a holder of a contingent event certificate 606 or right for a next generation gaming system, if the contingent event certificate 606 or right matures, gain the right to purchase a contingent event certificate 606 or right for a sequel to a video game compatible with the next generation gaming system at a predetermined price. In another example, a holder of a contingent event certificate 606 or right for a first round NBA playoff game may, if the contingent event certificate 606 or right matures, gain the right to purchase a second round NBA playoff game contingent event certificate 606 or right at a predetermined price. Many other such combinations 692 of a contingent certificate or right with another right will be appreciated and all such examples are within the scope of the present disclosure.

A contingent event certificate 606 or right may obligate the holder to make a purchase at a future time 694, perhaps when the contingent event certificate 606 or right matures. A contingent event certificate 606 or right may mature at a time 694 when the contingency associated with the contingent event certificate 606 or right is met such that it is no longer contingent. In effect, a contingent event certificate 606 or right becomes an event certificate when the contingency is no longer in question. In an example, a future item may include a seat at a second round NBA playoff game. The contingency may include a specific team, such as the Boston Celtics, participating in the game. A contingent event certificate 606 or right for this contingent event may be sold or traded anytime up until the event. However, the contingent event certificate 606 or right remains contingent until it is known with absolute certainty that the Boston Celtics will participate in the second round NBA playoff game. At some time 694, it may be determined that the Celtics have satisfied the requirements established by the NBA to participate in the game. Specifically this may include having a regular season and first round playoff win-loss record that is better relative to at least some other teams in the regular season and first round playoffs. When the Celtics have met all the criteria as defined by NBA, the contingent event certificate 606 or right may mature and be known as an event certificate or ticket.

However, the contingent event certificate 606 or right may expire when the Celtics do not win enough regular season games to participate in the playoffs, or if the Celtics are eliminated in the first round of playoffs from further contention, or if the Celtics are eliminated in the second round of playoffs before the event. This last expiring condition may occur if the contingent event certificate 606 or right is for a 4th game in a best of 5 game series and the series is completed in three games.

A contingent event certificate 606 or right may be contingent 608 upon an aspect of a sporting event. For example, a user may want to see a particular American League baseball team play a National League baseball team regardless if it is a post-season game or not. If the match-up is announced, the contingent event certificate 606 or right may mature. In another example, a contingency of a CEC 606 may be that a particular player joins a team, a particular team plays in a specific city, a team makes the Wild Card slot, and the like. In another example, a user may want to see a specific player in a championship, such as Roger Federer in the US Open. If Roger Federer survives the bracket and makes it into the US Open, the contingent event certificate 606 or right may mature.

A contingent event certificate 606 or right may be contingent 608 upon the timing 694 of an event. For example and without limitation, two contingent event certificates 606 or rights may be issued as rain checks for a rained out baseball game before the rain date has been set. Both may be contingent 608 upon the timing 694 of the game on the rain date, with one certificate or right maturing if the rain date is set for a day game and the other maturing if the rain date is set for a night game. Similarly, the timing 694 may relate to whether the rain date is a weekday, weekend, holiday, and so forth. Many other such examples of timing 694 will be appreciated and all such examples are within the scope of the present disclosure.

A contingent event certificate 606 or right may be associated with an advertisement 602. The holder of the certificate or right may be entitled to view, receive, produce, transmit, et cetera an advertisement 602 if and when a contingency becomes defined. For example and without limitation, two advertisers may each purchase a contingent right for a television-advertising slot. The first advertiser may be interested in advertising sunglasses when the forecast is for sunny weather. The second advertiser may be interested in advertising goulashes when the forecast is for rainy weather. The advertisers may purchase the contingent rights in advance of the forecast being known for the time of the slot. When the weather forecast becomes known, one of the rights may mature and the other may expire, depending upon forecast and the contingent right. Many other such examples related to advertising 602 will be appreciated and all such examples are within the scope of the present disclosure.

A future item 624 associated with a contingent event certificate 606 or right may be an event such as a performance, competition, or other participatory event; a product launch; a service offering, and the like. The future item 624 may alternatively be associated with a publication 601. The future item 624 may be associated with the publication 601 of one or more publications. The contingent event certificate 606 or right may be contingent upon a time associated with the publication 601, a release, an availability, and the like. For example, a contingent event certificate 606 or right may entitle a holder to purchase a copy of a first printing of a publication 601 upon its release. In this example, a holder of a contingent event certificate 606 or right may be obligated to purchase the first printing of a new book immediately upon release. In this way, the publisher may be motivated to make the first printing knowing that the holders of the contingent event certificate 606 or right for this future item 624 will be obligated to purchase the publication 601 at a predetermined price. The holder of the contingent event certificate 606 or right may be willing to acquire this contingent event certificate 606 or right so that they know they have the right (as well as the obligation) to purchase the first printing of the publication 601.

Music 630 and reunions of certain musical groups hold a great attraction for many people. A contingent event certificate 606 or right that could entitle a holder to a copy of the first distribution of a new recording of a reunited musical group may also be popular and generate interest in the reunion. Determining the likelihood that a reunion and recording would be economically viable may be difficult. Proceeding with the reunion and recording may present personal challenges to the band members as well as financial risks to the band, their promoters, recording label, and the like. The musical group and those who may be taking a risk related to the reunion and recording may use contingent event certificates 606 or rights as a measure of the reward potential of a reunion and recording. Additionally, the musical group may receive some income from the sale of contingent event certificates 606 or rights that may be used to pay for some of the recording related costs before the recording is complete.

A contingent event certificate 606 or right provides a holder with certain rights that may be related to a future item 624 associated with the contingent event certificate 606 or right. The rights may relate to a future purchase associated with the future item 624. The rights, being related to a future item 624, may not be exercisable until a contingency associated with the future item 624 is satisfied. If the contingency is not satisfied, the rights may expire.

The contingent event certificate 606 or right may represent an agreement between the holder of the contingent event certificate 606 or right and a provider of the future item 624. Therefore the future item provider may also have rights associated with the contingent event certificate 606 or right. The future item provider may have the right to receive compensation from the holder of a mature contingent event certificate 606 or right in exchange for the ticket, seat, or other good or service to which the holder of the contingent event certificate 606 or right is entitled.

In addition to rights related to a future item, a holder of a contingent event certificate 606 or right may have other rights such as the right to sell or exchange the contingent event certificate 606 or right through a contingent event certificate or right market platform 658 as herein described.

A contingent event certificate 606 or right may facilitate a business rewarding one or more employees if a set standard or goal is achieved. A contingency for a contingent event certificate 606 or right may include achieving the set standard or goal. In this way a business can use a contingent event certificate 606 or right to provide a reward to an employee contingent on the employee or the business achievement.

As an example, a business may provide contingent event certificates 606 or rights to a work team of employees, consultants, contractors, officers, and participants of the work team. The contingent event certificate 606 or right may provide the work team a right to a future item contingent on the work team achieving a set standard or goal. The work team may be charged with producing a prototype of a new product. The future item may be a night out on the town that is contingent upon the prototype's being produced before a deadline. If the team produces the prototype by the deadline, the contingent event certificate 606 or right may mature such that the contingent event certificate 606 or right would entitle the holder to the night out on the town.

A contingent event certificate 606 or right may include a plurality of associated future items, such as access to a season of events. The plurality of associated future items may be contingent on an acceptance of an agreement related to the future items. The plurality of future items may be contingent on a plurality of contingencies. Examples of a contingent event certificate 606 or right including a plurality of associated future items includes a season of lawn care services, a sports team season ticket for all home games, a pass to all concerts in a concert tour, a pass to all opening nights at an opera house for a season, and the like. The plurality of future items may include certain terms that a holder of a contingent event certificate 606 or right must agree with before the holder may redeem a mature contingent event certificate 606 or right. Such a term may include a ban on smoking at the event venue. In another example, the associated event may be a party on the lawn within a concert. For example, a user may purchase a contingent event certificate 606 for a block of lawn seats to a Jimmy Buffett concert with the contingency that the concert be located in Foxboro, Mass. If the concert is scheduled to be in Foxboro, Mass., the user may be obligated to purchase the block of lawn seats, but may also have the opportunity to hold a party on the lawn during the concert. In an embodiment, the opportunity to have a party may be sold as a separate contingent event certificate 606 or may be sold as part of the seats' contingent event certificate 606.

A contingent event certificate 606 or right that may include a plurality of associated future items may be split up by a holder of the contingent event certificate 606 or right into subsets of the associated future items such as individual future items. Such a split may facilitate the holder of the contingent event certificate 606 or right for a plurality of future items to sell or exchange one or more contingent event certificates 606 or rights for the subset of future items. However, a contingent event certificate 606 or right for a plurality of future items may be restricted from being split thereby obligating the holder or holders to exchange the contingent event certificate 606 or right for the plurality of future items as a whole.

A plurality of future items for a contingent event certificate 606 or right may be contingent on a plurality of future items. As an example, a plurality of future items may include a seat at each home playoff game of a sports team. The plurality of future items is contingent on the team reaching the playoffs and then continuing to win in the playoffs such that further home games may be played. If the team does not make the playoffs, the contingent event certificate 606 or right for the plurality of home playoff games expires. Likewise if the team fails to advance beyond the first home playoff game, the contingent event certificate 606 or right would expire.

A contingent event certificate 606 or right may be tradable such as through exchange or sale on a contingent event certificate or right platform 658, or by exchange with the event producer or event ticket provider for another event. However, a contingent event certificate 606 or right may be non-tradable 605.

As an example, a contingent event certificate 606 or right for a future event may occur at a time when a holder of the contingent event certificate 606 or right is traveling out of the country and cannot attend the event. The holder may wish to exchange the certificate for another event they can attend. However, the certificate may obligate the holder to make a purchase associated with the event, and therefore the event producer may not accept the contingent event certificate 606 or right in trade for another event ticket or contingent event certificate 606 or right. Yet the holder of the contingent event certificate 606 or right may sell or exchange the contingent event certificate 606 or right through the contingent event certificate 606 or right platform, effectively transferring the purchase obligation to a new holder.

A contingent event certificate 606 or right may include security features 609 and may provide a secure form of agreement between the holder and the future item producer. To ensure an agreement between a holder of a contingent event certificate 606 or right and future item producer is secure, a contingent event certificate 606 or right platform facilitator may require a potential buyer or holder of a contingent event certificate 606 or right to provide critical information such as credit cards and the like to secure the holder's obligation to make a purchase if the contingent event certificate 606 or right matures.

The contingent event certificate or right platform 658, and the contingent event certificate 606 or right itself may be secure and protected from malicious intent of others. The contingent event certificate 606 or right may include a serial number that is associated with the holder of the contingent event certificate 606 or right such that only the holder of the contingent event certificate 606 or right may authorize sale, exchange, or redemption of the contingent event certificate 606 or right.

Sports fans, music fans, NASCAR fans, and fans in general often collect and/or trade memorabilia. A contingent event certificate 606 or right may be associated with such memorabilia. A contingent event certificate 606 or right may be provided to a holder in a collectible 611 format such as a framed certificate. In this way, even an expired contingent event certificate 606 or right may be collectible 611.

A contingent event certificate 606 or right may include a collectible item. A contingent event certificate 606 or right for a collectible item may include a contingency associated with the collectible item. For example, a contingent event certificate 606 or right for a collectible item may entitle a holder of the contingent event certificate 606 or right to an autographed photograph of New England Patriots quarterback Tom Brady if the Patriots win the National Football League title game. In this example, the collectible item is the autographed photograph, and the contingency is the Patriots winning the title game.

Advertisers 613 may be associated with contingent event certificates 606 or rights. Advertisers 613 may be associated with an event of a contingent event certificate 606 or right. Advertisers 613 may be associated with a contingent event certificate or right platform 658. Advertisers 613 may be associated with the sale, exchange, and redemption of a contingent event certificate 606 or right. Advertisers 613 may provide a producer of a contingent event certificate 606 or right with compensation to be associated with the contingent event certificate 606 or right. For example, an advertiser of bicycling equipment may pay a producer of a contingent event certificate 606 or right for attendance to the Tour de France to allow the advertiser to promote bicycling equipment in association with the contingent event certificate 606 or right. This may come in the form of an internet ad campaign, advertisements 602 on a website of the contingent event certificate or right platform 658, print or other media indicating a sponsorship or promotion of the contingent event certificate 606 or right.

Advertisers 613 may also provide promotions to holders of contingent event certificates 606 or rights. An advertiser may, through coordination with a contingent event certificate or right platform 658 facilitator, gain access to a list of holders of contingent event certificates 606 or rights and may offer a promotion to the holders that may be associated with the future item. For example, an advertiser of tennis equipment may promote a tennis racket with custom markings associated with a tennis event to holders of contingent event certificates 606 or rights for the tennis event. Since the holders of the contingent event certificate 606 or right may already have a strong interest in the tennis event (and therefore may know about tennis), they may be more likely to respond positively to such an offer.

Producers 668 may be associated with contingent event certificates 606 or rights. Producers 668 may include merchant suppliers who may have originally proposed the particular future item associated with the contingent event certificate 606 or right. A producer 668 associated with a contingent event certificate 606 or right may include an entity, individual, or group who may hold rights related to the future item. Such an example includes an investor in the future item, a participant in the future item, an owner of a venue 614, an owner of a participating team 610, and the like. A publisher may be a producer 668 for a future item related to publishing such as a release of a new book. A consumer product company like Apple Computer or a consumer services company like AIG Insurance may be a producer 668 for an event related to the production of consumer products and consumer service offerings. In addition to sports participants, musicians, artists, manufacturers, distributors, retailers, service providers, and others may also be associated with a contingent event certificate 606 or right. An artist may receive a base portion of sales of contingent event certificates 606 or rights for an event that they are participating in. In addition the artist may receive other compensation based upon a contingency such as the number of contingent event certificates 606 or rights sold or the average sale price of a contingent event certificate 606 or right in a predetermined period of time.

Suppliers 664 associated with a contingent event certificate 606 or right may include manufacturers. Suppliers 664 of product launches 634 may be associated with a contingent event certificate 606 or right. A manufacturer may accept an obligation to deliver a product by a predetermined date and may receive a contingent event certificate 606 or right that is contingent on them fulfilling the obligation. In an example, a manufacturer may commit to producing 100,000 new games by October 15 to ensure they are available in retail outlets in time for holiday purchases. In exchange for this commitment, the manufacturer may receive a contingent event certificate 606 or right that may allow the holder to receive a portion of sales revenue for the new game. If the manufacturer meets the production commitment, the certificate may mature and the manufacturer may receive the portion of sales revenue. If the manufacturer does not meet the production commitment, the certificate may expire.

A producer 668 that is associated with a CEC 606 may include a content producer such as and without limitation an entity, individual, or group that may produce content or hold rights related to the production of content. Numerous types of content will be appreciated including, without limitation, content that is audio, video, multimedia, interactive, web based, text based, document based, digital, executable, interpretable, user generated, and so on. For example and without limitation, in embodiments the producer 668 may encompass an individual who produces an online video. A user of a social network may suggest the production of an online video. In response to this, the producer 668 may associate himself with that request and may offer to produce the online video contingent upon a certain number of users committing to view the video and a commercial that would be distributed along with the video. This commitment may be embodied as a CEC 606. Alternatively, the producer 668 may produce the online video contingent upon a certain number of users committing to purchase a copy of the video.

A market for a contingent event certificate 606 or right may be related to or integrated 670 with other markets such as financing markets 615. Related or integrated markets 670 may facilitate securing the underlying interest or security on which the contingent event certificate 606 or right value is initially established. If a contingent event certificate 606 or right is for a sporting event, such as a college bowl football game, or a consumer product or service, a related financing market 615 may be established to purchase (or guarantee to purchase) a plurality of event tickets or, in other examples, to facilitate manufacture and distribution of the product or provision of the service.

A related or integrated financing market 615 may provide a means for individuals, entities, and the like to participate in the open market sale and exchange of contingent event certificates 606 or rights without requiring a purchase or exchange of a contingent event certificate 606 or right. Participation in a related or integrated financing market 615 may allow a financing expert to identify a financing model that provides the level of security with upside potential that may facilitate receiving the necessary financial backing to establish the market for the contingent event certificates 606 or rights.

Financing sources for such a related or integrated market include venture capital, traditional banking, third party private lending, and any combination of these and other financing sources that may facilitate reducing risk to any of the combined financing sources. Venture capital may be a source of financing for establishing and maintaining the contingent event certificate 606 or right platform. Venture capital may also be a source of financing for continual financing event purchases to enable the establishment of the market. Traditional banking may also be included as a financing source in a related or integrated financing market. Traditional banks offer short term and long term interest rates to customers. Typically a short term investment produces a slightly higher interest rate than a long term investment. Financing associated with a contingent event certificate 606 or right may facilitate a traditional bank offering customers a short term base interest rate and a variable rate based on the value of contingent event certificates 606 or rights held by the bank.

A bank may offer its customers a contingent event certificate 606 or right for doing something such as signing up for on-line bill payment for example.

Finances to purchase or guarantee purchase of a plurality of one or more items associated with a future item (such as a product, a subscription, a ticket, a meal, a hotel room, and the like) may be provided by a variety of financing vehicles. These financing vehicles may include debt instruments such as loans, convertible securities that may have one or more conversion terms, revenue sharing agreements, and other vehicles as may be used to provide an investor a way of providing financing.

A convertible security may include providing financing in exchange for one or more options by which the inventor providing the financing is to be reimbursed. A conversion option may include converting at least a portion of the security to an ownership in the event, the contingent event certificate 606 or right platform, or the like. In an example, a holder of a convertible security may exchange repayment for the current event for a repayment of a future event. This convertible security may allow a holder of the security to continue to defer repayment. An objective of such a conversion option may be to allow the contingent event certificate 606 or right platform to continue to make purchases and issue new contingent event certificates 606 or rights with the potential of the holder of the convertible security to earn even greater return on their initial investment. The conversion option may facilitate converting at least a portion of current repayment to future repayment.

Financing vehicles may also be combined in contingent event certificate or right related/integrated markets 682, 670. A combination of vehicles may facilitate reducing a financial risk associated with the market for contingent event certificates 606 or rights. In an example, a debt instrument, providing repayment on a schedule at a fixed rate of interest may include a risk of default independent of the success of the contingent event certificate 606 or right offering. However, by combining a debt instrument with a revenue sharing agreement, a lender of a debt instrument may receive some portion of revenue of the contingent event certificate 606 or right offering which may mitigate the default risk.

A project financing market 615 related to a contingent event certificate 606 or right may be future item-based. Aspects of the financing market 615 may be dependent at least in part on the type of future item. A future item that may be cancelled, such as an outdoor concert, may impact a financing market differently than a future item such as a sports championship. The differences between these two types of future items may be reflected in the level of risk, and therefore the required reimbursement terms, of a related financing market for the future item. In an example, a concert by a single performer, such as Britney Spears, may have a measurable risk of being cancelled. A single performer may get sick, or may be delayed in travel, or may have personal problems that keep her from performing on any given night. Such an event has a quantifiable risk of being cancelled. This risk may be factored into the terms an investor may require for investing in a contingent event certificate 606 or right offering for the event and the investor may expect higher interests, a greater portion of revenue, and/or revenue from other of the performer's events.

A group event, such as a sports championship is unlikely to be cancelled, especially due to one person's physical or emotional health. In such an event, a financing market 615 may have different terms such as lower interest rate but higher revenue sharing as the chance of cancellation is nearly zero. Other events, such as product launches, tournaments, TV productions, theatre productions, movie premieres may have risks associated with the event but may be unlikely to be cancelled. A movie premiere may go on even if the star of the movie is not available to attend the premiere. While this risk may be factored in, and one or more contingent event certificates 606 or rights may include this as a contingency, the financing market 615 may be impacted differently.

Financing markets 615 for season based contingent event certificates 606 or rights (contingent event certificates 606 or rights for a plurality of associated events), may include financing to holders of mature contingent event certificates 606 or rights. Perhaps due to the typically larger cost of a season ticket compared to a single event ticket, a financing market 615 may be established in which the holders may borrow money to purchase the season tickets when the contingent event certificate 606 or right matures. The financing market 615 may include paying the venue producer for the season ticket and receiving reimbursement from the holder of the mature contingent event certificate 606 or right through a debt instrument or the like.

In an example of a season based contingent event certificate 606 or right, a mature contingent event certificate 606 or right may entitle (and obligate) the holder to purchase a season subscription to lawn care services. In another example of a season based contingent event certificate 606 or right, a mature contingent event certificate 606 or right may entitle (and obligate) the holder to purchase a season ticket to the Boston Symphony 2005-06 performance season. A financing market 615 for a season based contingent event certificate 606 or right may include a lender purchasing the season ticket and providing a ticket to individual BSO performances when the holder has made sufficient payment to the lender. If the holder does not make sufficient payment to the lender, the lender may do as they see fit with the ticket.

A project financing market 615 may be associated with a contingent event certificate 606 or right and may be based at least in part on an aspect of a seat at an event. An aspect of the seat may include a seat license, a season ticket for the seat, or a seating block related to the seat. The seat may be a single seat or a plurality of seats such as a block of seats (e.g. section 601 of the TD BankNorth Garden). A contingent event certificate 606 or right may include an obligation to license a seat associated with a venue 614 of the event.

A seat license may be financed through a secondary market that may include promoters, business entities, and others desiring a financial interest in the seat license. In an example, a contingent event certificate 606 or right may provide a holder with access to a seat that requires a license to use the seat and amenities such as parking passes, private entrance, lounge areas and the like. A seat license may also allow the licensee to have first right of refusal for a ticket for the licensed seat to all of the events held at the venue. A financing arrangement may include providing financing for the seat license in exchange for access to at least some portion of the events held at the venue. The holder of a contingent event certificate 606 or right that includes a seat license may agree to allow a financier of the seat license to have access to one-half of the tickets available to the holder.

A project financing market 615 associated with a contingent event certificate 606 or right may facilitate providing financing based at least in part on a venue 614 for an event. Venues 614 that may be associated with a project financing market 615 may include sports stadiums (e.g. baseball, basketball, football, soccer, rugby, and the like), golf courses, tennis stadiums, ski slopes, Olympic venues, race track (auto, dog, horse), arena, field, pitch, concert hall, theatre, lecture hall, retail stores, retail outlets, bookstores, and the like. Owners, mortgage holders, investors, and the like of one or more of these venues 614 may participate in a project financing market 615 to facilitate selling out events held at the venue 614. Such entities may wish to provide financing to one or more contingent event certificate 606 or right offerings to increase the probability that the amount of revenue they receive associated with the venue 614 may include sources other than ticket sales.

Referring again to FIG. 6, a market for a contingent event certificate 606 or right may be associated with a secondary 672 market 670 for a contingent event certificate 606 or right. Participants 600 such as financial participants and market participants in a market for contingent event certificates 606 or rights may access a secondary contingent event certificate or right market 670 through a user interface 619. The user interface 619 may allow a participant to post contingent event certificates 606 or rights on the secondary market for purchase, exchange, trade, or auction through a contingent event certificate 606 or right offer screen.

The user interface 619 may also allow a financial participant to monitor postings on the secondary market by viewing a certificate of authenticity of the contingent event certificate 606 or right. The user interface 619 may also allow a participant to place a bid for a contingent event certificate 606 or right and perform a transaction such as purchasing the contingent event certificate 606 or right on the secondary market.

A secondary contingent event certificate 606 or right market may include expired contingent event certificates 606 or rights. A participant user interface to a secondary contingent event certificate 606 or right market may include a listing of contingent event certificates 606 or rights available including a status of each contingent event certificate 606 or right (expired, contingent, mature). A secondary contingent event certificate 606 or right market may be integrated with a contingent event certificate 606 or right market to facilitate status updates and trading or exchange of CECs 606.

A user interface 619 between participants 600 and a project financing market 615 may facilitate a participant 600 determining the financing alternatives associated with the contingent event certificate 606 or right such as those associated with the product launch, service offering, service provider, the venue 614, the seat, the event, financing sources, and financing vehicles. In an example, a contingent event certificate or right market participant 600 may use a user interface 619 to view a listing of available financing alternatives and the type of contingent event certificate 606 or right for which they are eligible.

A project financing market user interface 619 may allow a financial participant of a contingent event certificate 606 or right market to view financing offers, compare financing scenarios, distribute request for financing a contingent event certificate 606 or right offering.

A project financing market user interface 619 may facilitate a project financier reviewing and interacting with the current financing of an ongoing contingent event certificate 606 or right offering. The user interface may include controls to facilitate releasing quantities of contingent event certificates 606 or rights to the marketplace.

Participants of a contingent event certificate 606 or right market may use a user interface 619 to facilitate viewing seat alternatives that may be associated with a mature contingent event certificate 606 or right. The user interface 619 may allow a participant to view a seating chart of a venue 614 and select at least one seat, section, area for purchase of a contingent event certificate 606 or right. The user interface 619 may allow a participant to experience the view angles from a particular seat or block of seats. The user interface 619 may allow a user to select the seat through the contingent event certificate or right market website or through a venue provider's website and be offered a contingent event certificate 606 or right that best fits the selected seat.

Participants of a contingent event certificate 606 or right market may use a user interface 619 to facilitate viewing a consumer product prototype that may be associated with a CEC 606. The user interface 619 may allow a participant to review proposed specifications, see different views of the prototype, learn more about the advantages of the product, and the like. The user interface 619 may allow a user to select a prototype of a consumer product through the contingent event certificate or right market website or through a producer's website and be offered a contingent event certificate 606 or right that best fits the selected prototype.

A participant 600 of a contingent event certificate or right market 682 may use a user interface 619 to select and or define an assignee to which a contingent event certificate 606 or right would be assigned if the contingent event certificate 606 or right matures. This aspect of a contingent event certificate 606 or right market user interface may facilitate affiliates or brokers 619 who may bid on one or more contingent event certificates 606 or rights but assign them to a third party that has made an agreement with the broker or affiliate to purchase the mature contingent event certificate 606 or right.

A participant user interface 619 of a contingent event certificate or right market 682 may facilitate access to related websites such as the venue website, the team or teams participating in the contingent event, a product retailer, a social networking website, a service provider website, and many others that may be related to the future item or a sponsor of the future item.

A financial or market participant user interface 619 of a contingent event certificate 606 or right market may facilitate a holder of a contingent certificate making a selection to post a CEC 606 to a rights resale market if the contingent event certificate 606 or right matures. The selection may be made by the participant as a condition of acceptance of the participant's bid. It may be made at the time a bid for the contingent event certificate 606 or right is accepted, or it may be made upon receipt of payment for the CEC 606.

An advertiser 613 may use a user interface 619 to access the contingent event certificate or right market platform 658. The advertiser 613 may use the user interface 619 to perform a transaction with the platform such as paying for placement of an advertisement 602. The advertiser user interface 619 may also facilitate the advertiser 613 accessing demographics of holders of contingent event certificates 606 or rights. An advertiser 613 may also use the user interface 619 to enable the back end production of new future items that reach a pre-established threshold of demand. Advertisers 613 may also use the user interface 619 to author new proposals for future items, such as consumer products and services. In an embodiment, the proposal may only be distributed in a limited fashion, such as to the advertiser's 613 employees so that new future items may be nominated by the advertiser 613 for production, distribution, and retail to a wide audience.

Advertisers 613 may also use a user interface 619 to a contingent event certificate or right market platform 658 to review contingent event certificate 606 or right offering sale and exchange performance related statistics. The advertisers 613 may use demographic and contingent event certificate 606 or right offering performance information to provide targeted advertisements 602 to participants of the market.

Producers 668 may interact with a contingent event certificate or right market platform 658 through a user interface 619. The user interface 619 may facilitate an event producer's 668 releasing allocations of contingent event certificates 606 or rights to be sold or exchanged through the market platform 658. In an example, a producer 668 may choose to manage releases of contingent event certificates 606 or rights over time to maintain interest in the future item and to provide participants the opportunity to purchase a contingent event certificate 606 or right.

The producers 668 may also use the user interface 619 of the contingent event certificate 606 or right market to identify rules associated with the contingent event certificates 606 or rights. The producers 668 may use the user interface 619 to monitor contingent event certificate 606 or right activity such as transaction rates, fees, sale prices, and the like.

Producers 668 may also use the user interface 619 of the contingent event certificate 606 or right market to price future item proposals. For example, if a producer 668 nominates a new toy, and wants it produced by a backend toy producer, the producer 668 may need to “presell” a threshold number of the toy. However, the producer 668 may need to give the price for the toy to the offerees. As a single inventor, the producer 668 may not be able to price the toy so the backend toy producer would have to look at the concept, estimate the retail value, and likely “approve” the proposal before it is released into the market or social network. Producers 668 may have a “review” and “approval” process for future item proposals before they get generally released into the market or social network.

Employees, loyalty club members, fan club members, season ticket holders, registered users, pre-selected users, pre-qualified users, or others closely associated with a producer 668 may be identified through the producer user interface 619 such that the platform 658 provides them an offer of a contingent event certificate 606 or right in advance of a public offering of the contingent event certificates 606 or rights. In essence, this may be a private market prior to opening the CEC market 682 to a wider audience. For example, as a registered user of CBS Sportsline, users may have a window of time, such as for 48 hours, to purchase CECs 606 for the Final Four prior to the general public.

Producers 668 may use the user interface 619 to coordinate demand 622 associated with the contingent event certificate 606 or right offering and/or the future item. A producer 668 may identify a threshold, such as a threshold of contingent event certificate 606 or right offer transaction activity, and may use the user interface 619 to establish this threshold in the platform 658. For example, the threshold may be associated with a demand 622 for a new children's toy. The producer 668 may use the user interface 619 to receive an alert if the threshold is exceeded. The producers 668 may then use the user interface 619 to manage one or more aspects of the contingent event certificate 606 or right offering.

A participant 600 of a contingent event certificate or right market 682 may associate a contingent event certificate 606 or right he/she is holding with a social network facility 616, which may provide, comprise, encompass, or otherwise be associated with social networking website. A user interface 619 for the social network site may allow a user to enter a link to a listing on the contingent event certificate or right platform 658 of the contingent event certificate 606 or right the user currently has to offer.

A contingent event certificate market platform 658 may be hosted on a computing facility, such as and without limitation a server. The host 660 may be a computer system that provides services to other computing systems and clients over a network, such as a local area network, wide area network, wireless network, intranet, the Internet, or the like. The server may be a computer system that operates continuously on the network and provides full-time access to the contingent event certificate market platform 658. The host 660 may provide a facility for an application server, database server, file server, client-server, or the like. The host 660 may provide hardware and/or software in support of the hosting of the contingent event certificate market platform 658. Host 660 hardware may include a central processing unit; input/output (I/O) facilities, such as keyboards, displays, disk drives, modems, network cards, or the like; memory, such as RAM, ROM, or the like; mass memory, such as optical discs, hard disks, or the like; or other such computer hardware. Host server software may include system software, program software, application software, business software, databases, or the like.

The host 660 may provide software-based services for users of the contingent event certificate market platform 658 that may provide personalized access capabilities, which may be adapted for consumers, event producers, manufacturers, distributors, retailers, service providers, advertisers, social network interfaces, related/integrated markets, or the like. Users may have customized access to host services of the contingent event certificate market platform 658 through a web portal, where access may be dependent upon the type of user, such as a username/password customer interface for contingent event certificate 606 transactions, a secure access for producers 668, customer service access for advertisers 613, or the like. The host 660 may provide access to data storage for users of the contingent event certificate market platform 658, such as user information, billing information, event information, contingent conditions, certificate tracking of ownership and price, or the like. The host 660 may also provide facilities for providing tickets or contingent event certificates 606 to users, system security, internationalization and technological interface to users, or the like.

The contingent event certificate market platform 658 may provide for a facility to fulfill user orders (fulfillment 662), and send the user a physical document in the form of a contingent event certificate 606, event ticket, receipt, voucher, product, or the like. The document may be printed and physically mailed to a user-specified shipping address, bought at a ticket window or box office, printed at a store by a store employee, printed at a kiosk by the user, or the like. The document may include a facility for identification and authentication of the document by ID number, barcode, magnetic stripe, password, biometrics, or the like. The document may have an element for securing against counterfeiting, such as special paper, treatments to the paper, intricate artwork, holograms, or the like. The contingent event certificate market platform 658 may allow for the transfer of ownership of the contingent event certificate 606. Transfer of ownership may be performed on-line, by phone, at a ticket window or box office, at a store, a kiosk, or the like. Transfer of ownership may result in a new contingent event certificate 606 identification number being generated, and a new document sent to the new owner. Fulfillment 662 of contingent event certificate 606 orders may also take other forms, such as a pass card, a discount pass, a club card, a season pass, or the like. The document may have the facility to add or subtract contingent event certificate 606 registrations, interface with a computational facility, scanned for entrance to an event, or the like.

The contingent event certificate market platform 658 host 660 may comprise a facility for storing data. Data may include user information, billing information, product information, service offering information, event information, contingent conditions, certificate tracking of ownership and price, or the like. Data may be stored local to the contingent event certificate market platform's 682 host 660, such as within the same physical memory space as applications software, operating software, or the like. Data may be stored remote from the contingent event certificate market platform's 682 host 660, such as in a separate memory, separate computer resource, content delivery networks, content distribution networks, or the like. Data stored in the contingent event certificate market platform 658 may be accessible by customers, social networks, advertisers 613, producers 668, related/integrated markets 670, or the like. Access to data within the contingent event certificate market platform 658 may require authentication, such as a username, password, security code, or the like. Data may also continually change to reflect changing event information, pricing, threshold demand levels, contingent changes, or the like.

The contingent event certificate market platform 658 may provide security against risks associated with computer use. Techniques for reducing risks to computer security associated with the contingent event certificate market platform 658 may include providing backups, anti-virus software, firewalls, access control lists, authorization and authentication software, encryption, intrusion-detection systems, or the like. Backups may be a continuous or scheduled activity within the system, and may provide for the copying of data so that these additional copies may be restored if the originals are damaged or lost. Anti-virus software may include computer programs that attempt to identify, thwart, and eliminate computer viruses and other malicious software. Firewalls may help protect the contingent event certificate market platform 658 from intrusions by restricting network traffic, which may be based on a set of system administrator defined rules. Authorization may restrict access to the contingent event certificate market platform 658 to a group of users, such as customers, registered users, manufacturers, distributors, retailers, service providers, event producers, contingent event certificate market platform 658 employees, or the like. Restrictions may be accomplished through the use of authentication systems. The contingent event certificate market platform 658 may employ encryption to protect messages, or intrusion-detection systems that scan the network for unauthorized users and activities.

The contingent event certificate market platform 658 may provide internationalization of user interfaces 619 such as language translation, currency conversion, location-based services, or the like. The contingent event certificate market platform 658 may provide for a user interface 619 that includes access to the system through a plurality of languages, language translations, translator services, or the like. Languages may include English, Spanish, German, French, Portuguese, Italian, Japanese, Russian, Chinese, or the like. The contingent event certificate market platform 658 may provide for a user interface 619 that includes access to currency conversion. Currencies may include the US dollar, Canadian dollar, Euro, Pound, Yen, Ruble, or the like. Currency conversion services may be associated with the currency of the user. For instance, a user that has selected German as their user interface language may cause the contingent event certificate market platform 658 to choose the Euro as the default currency for the exchange, with alternate currencies made available as selected by the user.

The contingent event certificate market platform 658 may provide for location-based services, such as a service based on cell phone location, IP address, user self-entry, internet service provider location, event location, or the like. An example of a location-based service may be a user placing a phone call from a cell phone in Italy for an event located in Italy. The contingent event certificate market platform 658 may set a priority for Italian as the user interface language because of the location of the user and the relevance of an event located in Italy. The contingent event certificate market platform 658 may also provide for alternative languages for the user to choose from, for example, in the instance of an English speaker visiting Italy, and attempting to acquire tickets to a show in Italy as a part of the English speaker's vacation. The contingent event certificate market platform 658 may also provide for a default currency based on a future item location, such as the peso being selected as the default currency based on the future item's bring produced, offered, or taking place in Mexico City.

The contingent event certificate market platform 658 may be accessed through the Internet from a plurality of sources, such as a computer, PDA, phone, mobile phone, cellular phone, GSM phone, network client device, or the like. The computer may be used to connect to the Internet, for example, using the computer's internet browser the user may connect to the contingent event certificate market platform 658 though the user's internet service provider. The user may also be able to connect to the contingent event certificate market platform 658 through the browser of the user's mobile communications facility, such as through the user's PDA, mobile phone, cellular phone, GSM phone, or other network client device known to the art. For example, a user of a cell phone may use the Internet connectivity of their cell phone to connect to the contingent event certificate market platform 658 through their wireless provider's distributed communications facility and Internet gateway.

The contingent event certificate market platform 658 may be accessed through the telephone system, such as from a phone, a mobile phone, cellular phone, GSM phone or the like. A user may place orders for contingent event certificates 606, trade contingent event certificates 606, schedule events, arrange for advertisements 602, or the like. Wireless providers may offer customers special access promotions to contingent event certificate's 606 and other products which customers access via cell phones. For example, a wireless provider may provide a discounted service that can only be accessed though their wireless service. Another example may be a wireless provider reserving special access to blocks of reserved tickets.

User interfaces 619 to the contingent event certificate market platform 658 may include and/or be associated with a social network facility 616 (the “social networks”). Social networks may be communities that in some part utilize the Internet as an element of their social organization. Examples of social networks may be MySpace, Friendster, Facebook, Gaia Online, orkut, Piczo, Yahoo! “360,” or the like. Internet social networks may be formed through an initial set of founders who invite members to join their site. New members may repeat the process, growing the total number of members and links in the network. Sites may offer features such as automatic address book updates, viewable profiles, the ability to form new links through introduction services, or other forms of online social connection known to the art. Social networks may also be organized around other connections such as ethnic groups, entertainment media, schools, services, business, age groups, sports, games, travel, technologies, dating, or the like.

Social networks may utilize a blended networking approach that may combine online activities with offline elements, such as face-to-face events. Examples of this blended approach may be MySpace, that associates its online activity to independent music and party gatherings, or Facebook that associates with activity within the college community. Social networks on the Internet may also be focused on specialized activities such as art, tennis, football, soccer, golf, cars, dog owners, or the like. These networks may provide a virtual extension of a groups' activities such as sharing photos, video, stories, planning, group rates, or the like. Internet social networks may also provide specialized interfaces to outside activities that are associated with the social network's focus. An example of this may be an Internet social network focused on football that interfaces with sport fan clubs, fantasy football leagues, online sports reviews, ticket suppliers, or the like. Social networks may also enable the distribution of user generated content proposals. For example, a social network member may receive a user generated content proposal from a member of her social network then forward it on to her social network with an associated comment, request, or the like.

The contingent event certificate market platform 658 may have an interface with Internet social networks, which may be depicted as an association between the social network facility 616 and the platform 658. These social networks may have specialized interfaces with the contingent event certificate market platform or 682 be the result of social interaction within the social network. The interface between the contingent event certificate market platform 658 and the social network may include selection of existing buy and sell options, monitoring of personal buy and sell status, viewing of existing events, initiation of a contingent event certificate 606 for a new future item, the initiation of a contingent event certificate 606 for a future item that has already received other contingent event certificates 606 but is not an actual future item yet, monitoring of the aggregation of demand 622 for a future item, or the like. The interface may be implemented as an exchange between the social network's host servers and the contingent event certificate market 682 platform's 658 host 660 as a special interface between the two networks or a general interface such as with any other customer.

A future item being produced may be contingent upon the demand 622 that is aggregated for the future item through contingent event certificate 606 generation and the threshold for demand 622 set for the future item to be produced. An individual customer may participate directly in the contingent event certificate or rights market 682. Alternatively, an individual may participate in the market 682 through the interface or association between the social network facility 616 and the contingent event certificate market platform 658. Individuals may have an interface to the contingent event certificate market platform 658 through social networks such as MySpace, Friendster, Facebook, Gaia Online, orkut, Piczo, Yahoo! 360, or the like. For instance, the Internet social network MySpace has online associations to independent music and party gatherings, and may provide an integrated interface to the contingent event certificate market platform 658. A MySpace member may initiate a contingent event certificate 606 for a new fashion magazine with a targeted editor and targeted columnists, and monitor the aggregation of demand 622 for the magazine. This aggregation of demand 622 may generate interest from an editor or columnist who then may set a demand threshold for enabling the magazine to be produced.

The demand aggregation process may be a dynamic interaction between customer demand 622 for a given future item, and the future item producer's required demand threshold to enable the future item to be produced. An Internet social network member may generate a contingent event certificate 606 for a future item that is not yet available, such as a video game from Electronic Arts, a music concert, a meeting of an artist, a match-up between sports teams, a lecture by a famous individual, or the like. Members of the Internet social network may then purchase contingent event certificates 606 for the future item and thereby aggregate demand 622 for the future item. Demand 622 for the future item, in the form of contingent event certificate 606 purchases, may be communicated to management facilities for relaying to supply future item producers. A producer 668 may in turn set a demand threshold for the future item to be produced, such as 20000 CECs for the new video game, Bob Dylan requiring a demand of 10,000 contingent event certificates 606 for a concert at Red Rocks, Colo., or the physicist Stephen Hawking requiring a demand of 2,000 contingent event certificates 606 for a lecture at Albert Hall, London, or a 1970's punk rock star requiring 100 contingent event certificates 606 to come to a large party to meet the guests, or the like.

In an embodiment, a future item 624 for which demand 622 may be aggregated may be a digitally simulated performance. The digitally simulated performance may be a pre-recorded performance, an animated performance, a holographic performance, a spliced performance, a combination thereof, and the like. For example, a digitally simulated performance may be a video performance of a living performer singing with a deceased performer. The recording may be made by editing pre-existing images of a performance by a deceased performer to manipulate and modify the background of the pre-recorded performance. Manipulations may be done with any video editing technique, such as rotoscoping. Rotoscoping may allow an editor to trace around the deceased performer and digitally separate the background from the performer. Manipulating the background of the deceased performer may facilitate placing the deceased performer into a new environment or in front of a new background, such as one similar or identical to a living performer's environment. The pre-recorded, digitally simulated performance may comprise at least a portion of a recording of the living performer coordinating their performance with at least a portion of the recording of the deceased performer. The two recordings may be edited together to arrive at the pre-recorded digitally simulated performance. For example, a living performer may match a deceased performer's tempo, volume, pitch, energy, and the like in order to give the appearance that the two performers are singing together. During recording of the living performer's performance, the living performer may glance over at a position the deceased performer may occupy in the final digitally simulated performance in order to give the appearance that they were both present at the recording. To enhance the appearance that the living and deceased performer may be performing together, a body double may be included in the recording of some angles of the living performer's performance. In an example, the final digitally simulated performance may comprise the digitally manipulated video image of a deceased performer singing a song; the recording of a living performer singing the same song, wherein the living performer may appear to be singing with the deceased performer by matching certain qualities of a deceased performer's performance and by generally acting as if the deceased performer is present at their performance; and, optionally, a recording of certain camera angles with a body double. In some embodiments, such as for when the digitally simulated performance may be intended for a television audience of a program for which there may be a live studio audience, camera angles with a body double may be acquired during a live performance of the living performer with a body double and spliced in to a pre-recorded simulated performance. Other examples of digitally simulated performances may be an editing together of more than one performance by living performers, deceased performers, animated performers, any combination thereof, and the like.

In an embodiment, the digitally simulated performance may be a holographic performance. The holographic performer animations may be projected using any holographic projector, such as a video 3-dimensional projector system (e.g.: the Musion Eyeliner System). The 3-dimensional projector system may enable freeform 3-dimensional holographic moving images to appear within a live event stage setting. Additional technology may be used to enhance the holographic effect, such as illusionary techniques (e.g.: Peppers Ghost technology). In some embodiments, a plate glass and special lighting techniques may be used to make holographic objects seem to appear or disappear, or make one holographic object seem to “morph” into another. Holographic performer animations may be projected onto transparent film placed on a stage, creating the appearance that performers are actually present on the stage. In embodiments, a holographic performance may be accompanied by a live performance. For example, the holographic performance and the live performance may be timed so that it appears that a live performer is performing with a holographic performer.

Demand 622 for a digitally simulated performance may be aggregated as described herein. A demand aggregation facility 202 may provide an interface, such as a web site or web page that may include screens that a user 208 or future item provider 204 may use to request a digitally simulated performance be produced in response to obtaining, from users 208, digitally simulated performance-related commitments (such as and without limitation pre-orders for digitally simulated performance-related downloads and/or items). A user 208 may access the demand aggregation facility 202 directly or may be brought to the demand aggregation facility 202 by linking to it from another website, such as a website for a performer, a fan club, a production company, and the like.

Once a contingent event certificate 606 is obtained, either by being purchased, earned, or at no cost, it may be sold or traded prior to the future item being produced. The selling and trading of contingent event certificates 606 may be facilitated within the contingent event certificate market platform 658, such as with FanForwards, or within a secondary market place. FanForwards may be a way of buying and selling contingent event certificates 606 within the controlled environment of the contingent event certificate market platform 658. If the demand threshold for a future item is met, then the future item may be produced and purchasers of contingent event certificates 606 may be obligated to purchase the future item, such as a proposed consumer product, a subscription to a new service offering, a ticket to an event, and the like. If the demand threshold is not met, the holders of the contingent event certificates 606 may, or may not, receive refunds for the cost of their contingent event certificates 606, if in fact the CEC 606 was paid for and not obtained free of charge. The process of aggregation of demand 622 may drive a future item from being contemplated, such as an idea for a book, to being produced, offered, scheduled, or populated, such as publication of the book, and finally fixed for sale or, in the example of the book, shipped to contingent event certificate holders. Once the future item is fixed, contingent event certificate 606 holders may be able to purchase the actual item. If demand 622 does not reach demand threshold, no future item may be produced. During the process of demand aggregation, a secondary market place may allow contingent event certificate 606 holders to financially profit from the selling of contingent event certificates. For example, a forward market may be closed after a certain period of time or reaching a threshold of demand aggregated so that trading of forward rights on a secondary marketplace may begin.

Producers may register within the contingent event certificate market platform 658 or be contacted by a management facility in order to be made available for producing. Producers may include manufacturers, distributors, retailers, service providers, musicians, celebrities, lecturers, sports figures, entertainers, or the like. A producer may specify conditions under which they will produce a future item, such as if a certain minimum amount of money is guaranteed; if a particular authors writes the forward to a proposed book, if an event is in a certain location, date, venue 614; if there is a guaranteed number of performances per year; or the like. The producer may contractually bind themselves to these specified conditions, and monitor the demand aggregation for their services using the contingent event certificate market platform 658 user interface. The producer may have the option to accept conditions outside the initially specified conditions. For instance, if an event performer had originally specified New York City as the only location they would be willing to perform in, but monitors the demand 622 and observes a demand 622 for them to perform in different city, they may have the option to accept the new location and enable the performance to take place.

A facility for measuring and tracking the demand 622 for future items may be provided within the contingent event certificate market platform 658. The facility may provide for monitoring of demand 622 by individual customers, members of an Internet social network, event performers, event and event performer management facilities, manufacturers, distributors, retailers, service providers, or the like. The user interface may be sorted by demand, genre, such as music concerts, lectures, meet the celebrity, or the like; performers; locations, such as New York City, Boston, London, or the like; date; venue 614; and other like variables to be sorted. Since demand is a function of contingent event certificates 606, security measures may also be taken to ensure the validity of each contingent event certificate 606, such as supplying digital tags to each contingent event certificate 606.

Users may receive certain benefits as members of loyalty clubs of event performers and future item producers. A user may enroll in a club and purchase products associated with an event performer, future item, or future item producer, such as music downloads, tee-shirts, mugs, jewelry, accessories, books, or the like, from the club website. The user may earn loyalty points for each purchase, for carrying a retailer credit card, for serving on an opinion panel, for referring the producer to their friends, and the like. The loyalty club may offer contingent event certificate 606 promotions to users in possession of a certain number of points, or to the user with the greatest number of points, where the contingent event certificate 606 may be made available for purchase or given freely as a loyalty reward. In turn, the user in possession of the contingent event certificate 606 may sell the contingent event certificate 606 within a trading facility within the contingent event certificate market platform 658, in a secondary marketplace, within the loyalty club, or the like. For example, Best Buy may have a loyalty club where points are awarded for having a Best Buy consumer credit card, for purchasing electronic devices, for purchasing extended warranties, for using the Geek Squad service, and the like. Best Buy may offer a reward to those loyalty club members above a certain threshold number of points, such as advanced access to the new version of the iPod nano. In embodiments the methods and systems disclosed herein may be associated with an exchange, such as a contingent event rights exchange or a contingent event certificate exchange, which contingent event certificates are offered, issued and/or exchanged. The contingent event certificate exchange may allow exchange of contingent event certificates, as well as exchanges of other related items, such as tickets, whether issued by an issuer or a service provider for an issuer, or exchanged in a secondary market, such as between purchasers.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1-185. (canceled)

186. A method comprising:
offering a forward right for a future item, the forward right including a right to require a provider provide the item;
obligating holders of the forward right to purchase the future item upon its availability; and
based on the accumulation of a threshold extent of forward rights, obligating providers to provide the future item.

187. The method of claim 186, further comprising producing at least an obligated amount of a future item based on the response to the offer.

188. The method of claim 186, wherein the future item is a consumer product.

189. The method of claim 186, wherein the future item is a service offering.

190. The method of claim 186, wherein the future item is user-generated content.

191. The method of claim 186, wherein billing for the future item is automatic upon the future item's availability.

192. The method of claim 186, wherein the forward right is obtained at no cost.

193. The method of claim 186, wherein the forward right is earned.

194. The method of claim 186, wherein the forward right is purchased.

195. The method of claim 186, wherein the offer is presented to a social network.

196. A system comprising:
an offer of a forward right for a future item, the forward right including a right to require a provider provide the item;
an obligation of forward rights holders to purchase the future item upon its availability; and
an obligation of providers to provide the future item based on the accumulation of a threshold extent of forward rights.

197. The system of claim 196, further comprising a production of at least an obligated amount of a future item based on the response to the offer.

198. The system of claim 196, wherein the future item is a consumer product.

199. The system of claim 196, wherein the future item is a service offering.

200. The system of claim 196, wherein the future item is user-generated content.

201. The system of claim 196, wherein billing for the future item is automatic upon the future item's availability.

202. The system of claim 196, wherein the forward right is obtained at no cost.

203. The system of claim 196, wherein the forward right is earned.

204. The system of claim 196, wherein the forward right is purchased.

205. The system of claim 196, wherein the offer is presented on a social network interface.
